(19) United States
(12) Patent Application Publication
(10) Pub. No.: US 2026/0137018 A1
(43) Pub. Date: May 21, 2026

(54) WORKING VEHICLE

(71) Applicant: Kubota Corporation, Osaka-shi, (JP)

(72) Inventor: Hiroaki HOSOZAWA, Fremont, CA (US)

(21) Appl. No.: 19/380,096

(22) Filed: Nov. 5, 2025

Related U.S. Application Data
(60) Provisional application No. 63/722,696, filed on Nov. 20, 2024.

(51) Int. Cl. A01B 63/10; A01B 59/06

(52) U.S. Cl. CPC A01B 63/1006; A01B 59/068

(57) ABSTRACT

A working vehicle includes a travel vehicle body, a traveling device to support the travel vehicle body such that the travel vehicle body is allowed to travel, a linkage on the travel vehicle body to link a working device thereto, a drive actuator to move the linkage in an up-down direction to raise and lower the working device linked to the linkage, and a controller configured or programmed to perform a vibration control to control the drive actuator to vibrate the linkage.

### CROSS-REFERENCE TO RELATED APPLICATIONS

This application claims the benefit of priority to U.S. Provisional Patent Application No. 63/722,696 filed on Nov. 20, 2024. The entire contents of this application are hereby incorporated herein by reference.

### BACKGROUND OF THE INVENTION

### 1. Field of the Invention

The present invention relates to working vehicles such as tractors.

### 2. Description of the Related Art

The agricultural tractor disclosed in Japanese Unexamined Patent Application Publication No. 2014-011983 includes a traveling machine body on which a transmission case is mounted, a lift arm provided at the transmission case to be swingable up and down, a raising/lowering hydraulic cylinder that causes the lift arm to swing up and down, a lower link that allows a ground working machine to be linked thereto and that swings up and down in response to the lift arm swinging up and down, a raising/lowering hydraulic switching valve that controls supplying and discharging of a hydraulic fluid to and from the raising/lowering hydraulic cylinder, and a working-machine raising/lowering lever that mechanically switches the raising/lowering hydraulic switching valve.

### SUMMARY OF THE INVENTION

In the agricultural tractor in Japanese Unexamined Patent Application Publication No. 2014-011983, the working-machine raising/lowering lever is operated to actuate the raising/lowering hydraulic switching valve to be switched, thereby actuating the raising/lowering hydraulic cylinder to extend and retract. Consequently, the lift arm swings up and down to cause the lower link to swing up and down.

In the agricultural tractor in Japanese Unexamined Patent Application Publication No. 2014-011983, however, since switching of the raising/lowering hydraulic switching valve is mechanically performed by the working-machine raising/lowering lever (manual operator), operation of the lower link (linkage) depends on an operator who operates the manual operator. That is, there is a likelihood that the linkage does not vibrate appropriately even when an operator who operates the manual operator attempts to cause the linkage to vibrate.

Example embodiments of the present invention provide working vehicles in each of which a linkage is easily vibrated.

A working vehicle according to an example embodiment of the present invention includes a travel vehicle body, a traveling device to support the travel vehicle body such that the travel vehicle body is allowed to travel, a linkage on the travel vehicle body to link a working device thereto, a drive actuator to move the linkage in an up-down direction to raise and lower the working device linked to the linkage, and a controller configured or programmed to perform a vibration control to control the drive actuator to vibrate the linkage.

The controller may be configured or programmed to selectively perform a first vibration control or a second vibration control as the vibration control. A first amplitude of vibration of the linkage in the first vibration control may be greater than a second amplitude of vibration of the linkage in the second vibration control.

The controller may be configured or programmed to control driving of the working device linked to the linkage such that the working device is driven in the first vibration control and the working device is not driven in the second vibration control.

The controller may be configured or programmed to control a driven speed of the drive actuator such that the driven speed is higher in the first vibration control than in the second vibration control.

The working vehicle may further include an output shaft to transmit a rotational driving force to the working device linked to the linkage. The controller may be configured or programmed to control rotational driving of the output shaft, and, in the vibration control, repeatedly perform at least one of (i) a first switching control to switch a direction of rotation of the output shaft or (ii) a second switching control to switch between starting and stopping the rotational driving.

The controller may be configured or programmed to, in the vibration control, perform the first switching control or the second switching control as the linkage is moved up and down.

The controller may be configured or programmed to, in the vibration control, perform the first switching control or the second switching control when a direction of movement of the linkage is switched over.

The controller may be configured or programmed to control a driven speed of the drive actuator such that the driven speed in the vibration control increases with increasing distance from a center of an amplitude of up-down movement of the linkage to a maximum deviation of the amplitude.

The controller may be configured or programmed to, in the vibration control, vibrate the linkage such that a position of the linkage in the up-down direction at a time when the vibration control is started is a center of an amplitude of up-down movement of the linkage.

The working vehicle may further include a manual operator to receive an operation to cause the drive actuator to move the linkage in the up-down direction. The drive actuator may be operable to be controlled by a manual operation of the manual operator.

The working vehicle may further include an input interface to receive an instruction to perform the vibration control. The controller may be configured or programmed to, upon receipt of the instruction by the input interface, perform the vibration control instead of the control by the manual operation.

The controller may be configured or programmed to acquire a travel state of the travel vehicle body that is configured to be caused to travel by the traveling device, and stop or not perform the vibration control if determining that the traveling device is causing the travel vehicle body to travel based on the travel state.

The controller may be configured or programmed to acquire at least one of a specific position on the travel vehicle body or a specific position on the working device linked to the linkage, and stop or prevent upward movement of the linkage by the manual operation or stop or not perform the vibration control if, based on the at least one of the specific position on the travel vehicle body or the specific position on the working device, determining that at least one of the specific position on the travel vehicle body or the specific position on the working device is located in a work area in which work is performed.

The controller may be configured or programmed to acquire a travel state of the travel vehicle body that is configured to be caused to travel by the traveling device, and stop or prevent downward movement of the linkage caused by the manual operation if determining that the travel vehicle body is turning based on the travel state.

The drive actuator and the traveling device may be configured to be driven directly or indirectly by electricity discharged from a battery. The controller may be configured or programmed to stop or not perform driving of the drive actuator in the vibration control when a remaining charge level of the battery is less than a predetermined level.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 is a schematic side view of one example of a working vehicle.

FIG. 2 is one example of a block diagram of a working vehicle.

FIG. 3 illustrates one example of a hydraulic system of a working vehicle.

FIG. 4 is a perspective rear view of a raising/lowering device.

FIG. 5 is a left side view illustrating raising/lowering operation of a raising/lowering device.

FIG. 6 illustrates alignment between a connector and a mount member.

FIG. 7 illustrates operation of a linkage in vibration control.

FIG. 8 illustrates a comparison of vibration of a linkage between first vibration control and second vibration control.

FIG. 9 is a graph illustrating one example of a relationship between vibration control and driving of a working device in first switching control.

FIG. 10 is a graph illustrating one example of a relationship between vibration control and driving of a working device in second switching control.

FIG. 11 is a graph illustrating one example of a first map (graph) illustrating a relationship between a correction value and a difference between an actual position and a first target position.

FIG. 12 illustrates one example of a work area.

FIG. 13 illustrates another example of a work area.

FIG. 14 illustrates one example of a hydraulic system of a working vehicle in a variation.

FIG. 15 is a graph illustrating one example of a second map (graph) illustrating a relationship between first control electric current and a difference between an actual position and a target position.

FIG. 16 illustrates one example of a planned travel line.

### DETAILED DESCRIPTION OF THE EXAMPLE EMBODIMENTS

Example embodiments will now be described with reference to the accompanying drawings, wherein like reference numerals designate corresponding or identical elements throughout the various drawings. The drawings are to be viewed in an orientation in which the reference numerals are viewed correctly.

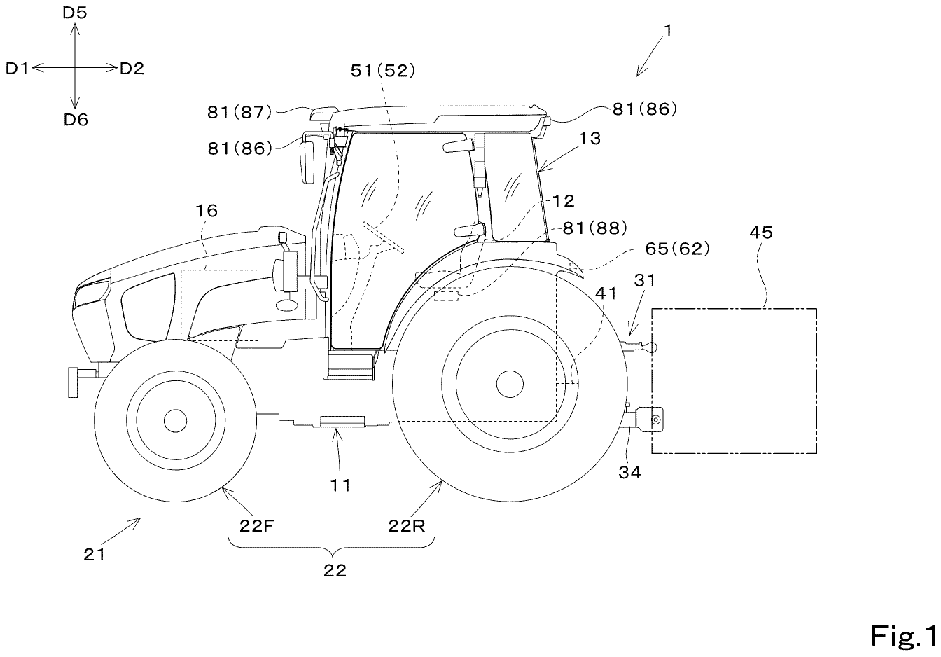

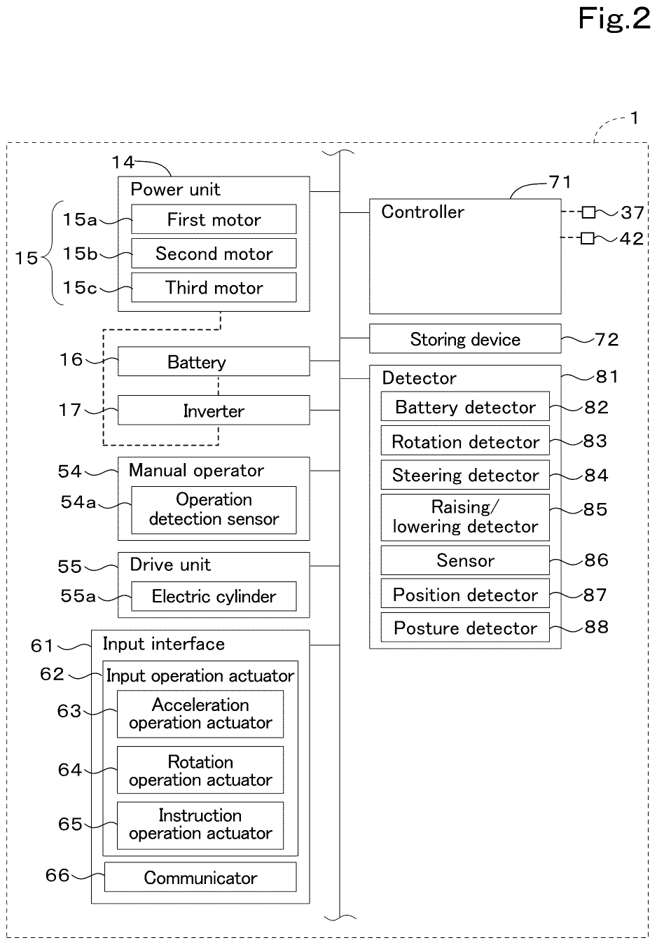

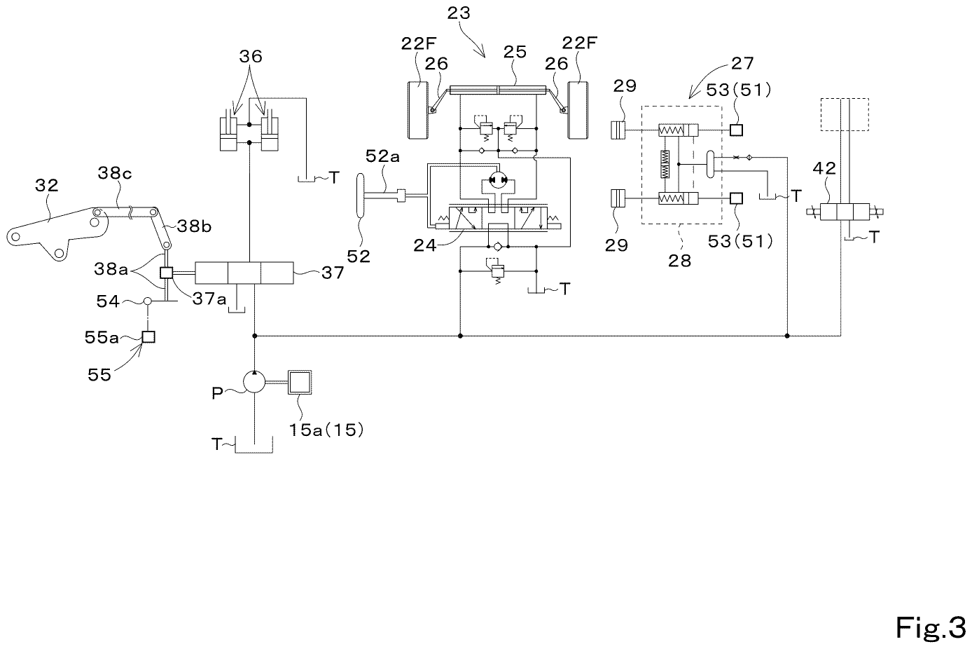

Hereinafter, example embodiments of the present invention will be described with reference to the drawings. FIG. 1 is a schematic side view of one example of a working vehicle 1. FIG. 2 illustrates one example of a block diagram of the working vehicle 1. FIG. 3 illustrates one example of a hydraulic system of the working vehicle 1. The working vehicle 1 is a vehicle operable to perform work with a working device 45. In the present example embodiment, the working vehicle 1 is a tractor in which the working device 45 (implement) is mountable on a travel vehicle body 11 (machine body). In the following description, a tractor including an operator's seat 12 and manually operated by a manual operation by an operator seated in the operator's seat 12 will be mainly described as description of the working vehicle 1.

Note that, although detailed description is omitted, the working vehicle 1 may be operated by automatic operation control not depending on manual operation by an operator or may be operated by a remote operation control by a manual operation on a remote operation device at a remote location. The working vehicle 1 is not limited to a tractor and may be a construction working machine, such as a compact track loader, a backhoe, or the like.

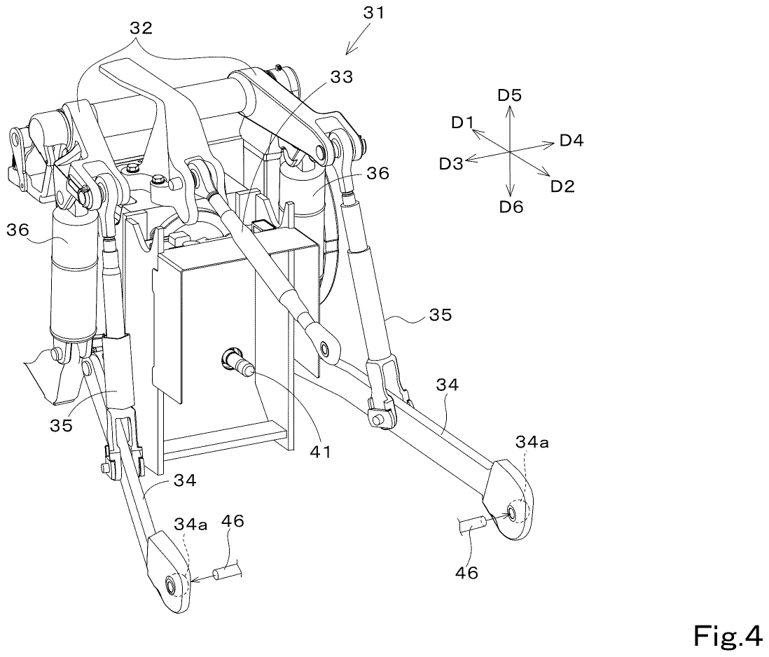

In the following description, the direction (arrow D1 in FIG. 1 and the like) that an operator seated in the operator's seat 12 of the working vehicle 1 faces is referred to as forward, and the direction (arrow D2 in FIG. 1 and the like) opposite thereto is referred to as rearward. The left side (near side in FIG. 1, arrow D3 in FIG. 4) of the operator is referred to as leftward, and the right side (far side in FIG. 1, arrow D4 in FIG. 4) is referred to as rightward. The upper side (arrow D5 in FIG. 1 and the like) of the operator is referred to as upward, and a direction (arrow D6 in FIG. 1 and the like) opposite thereto is referred to as downward. The horizontal direction, which is a direction orthogonal to the front-rear direction, is referred to as the width direction. In addition, the direction orthogonal to the horizontal direction is referred to as the up-down direction.

As illustrated in FIG. 1, the working vehicle 1 includes the travel vehicle body 11. The travel vehicle body 11 supports various devices and instruments included in the working vehicle 1. For example, the operator's seat 12 and a protecting mechanism 13 for protecting the operator's seat 12 are provided on the travel vehicle body 11. The protecting mechanism 13 is, for example, a cabin that surrounds the periphery of the operator's seat 12. The protecting mechanism 13 is not limited to a cabin and may be a canopy or a ROPS installed upright forward or rearward of the operator's seat 12.

Additionally, an operation device 51 for operating devices and instruments included in the working vehicle 1 is provided around the operator's seat 12. The operation device 51 receives manual operation performed by an operator. The operation device 51 is not limited to be provided around the operator's seat 12 and may be located at a position other than around the operator's seat 12. For example, at least a portion of the operation device 51 may be located at an exterior cover and/or the like of the travel vehicle body 11.

The working vehicle 1 includes a power unit 14. The power unit 14 is a device that generates power. The power unit 14 is mounted on the travel vehicle body 11. In the present example embodiment, the power unit 14 includes one or a plurality of electric motors 15 and generates power (rotational driving force) by the one or plurality of electric motors 15. That is, the working vehicle 1 in the present example embodiment is an electric working vehicle that is driven by the one or plurality of the electric motors 15.

Each electric motor 15 is a permanent-magnet embedded AC synchronous motor, a wound-field synchronous motor, or the like. A rotary shaft (motor shaft) of the electric motor 15 is directly or indirectly connected to a power supply target to transmit generated power to the power supply target. The motor shaft of the electric motor 15 is indirectly connected to a power supply target via, for example, a transmission including a plurality of gears.

Each electric motor 15 is driven by electricity supplied from a battery 16. The battery 16 is mounted on, for example, the travel vehicle body 11. The battery 16 is operable to store electricity and is, for example, a secondary battery, such as a lithium ion battery, a lead storage battery, or the like. The battery 16 includes a plurality of cells in an inner portion thereof, and the plurality of cells are electrically connected in series and in parallel to each other. As illustrated in FIG. 2, a power supply path connecting the battery 16 and each electric motor 15 to each other is provided with an inverter 17, and the inverter 17 changes the electric current and the voltage of the electricity that is to be supplied from the battery 16 to each electric motor 15.

The power unit 14 is operable to supply power to devices and instruments included in the working vehicle 1. When the power unit 14 includes a plurality of the electric motors 15, the electric motors 15 may supply power to different devices and/or different instruments, or the plurality of devices and/or instruments may be supplied with power by a common electric motor 15.

For example, as illustrated in FIG. 3, the power unit 14 supplies power to a hydraulic pump P included in the working vehicle 1 to actuate the hydraulic pump P. In the present example embodiment, the hydraulic pump P is supplied with power from an electric motor 15a included in the power unit 14. Consequently, the hydraulic pump P is actuated by the power generated by the electric motor 15a. Hereinafter, the electric motor 15a (motor for pump) that supplies power to the hydraulic pump P will be described as a “first motor”.

The hydraulic pump P delivers a hydraulic fluid stored in the hydraulic-fluid tank T. The hydraulic pump P includes a fixed displacement gear pump or a variable displacement hydraulic pump that includes a pump-displacement controlling mechanism, such as a swash plate or the like. Therefore, the hydraulic pump P is operable to change the delivery amount of the hydraulic fluid in response to a change in the rotational speed of the power that is supplied from the first motor 15a. When the hydraulic pump P is a variable displacement hydraulic pump, the hydraulic pump P is operable to change the delivery amount of the hydraulic fluid in response to a change in the angle of the swash plate.

Note that, although an electric working vehicle that includes the power unit 14 including one or a plurality of the electric motors 15 is described as an example of the working vehicle 1 in the present example embodiment, the power unit 14 may include another prime mover instead of or in addition to the one or plurality of electric motors 15. For example, the power unit 14 may include an engine (internal combustion engine), such as a diesel engine, a gasoline engine, or the like, and the internal combustion engine may supply power to devices and instruments.

As illustrated in FIG. 1, the working vehicle 1 includes a traveling device 21. The traveling device 21 is a device that supports the travel vehicle body 11 such that the travel vehicle body 11 is allowed to travel. The traveling device 21 applies a propelling force to the travel vehicle body 11 by being driven. The traveling device 21 includes one or a plurality of wheels 22 that are supported by the travel vehicle body 11 such that the wheels 22 are allowed to rotate. In the present example embodiment, the traveling device 21 includes a plurality of the wheels 22, and the plurality of wheels 22 are arranged to be separated from each other in the front-rear direction or the width direction. The traveling device 21 includes a pair of wheels 22F (front wheels) that support a front portion of the travel vehicle body 11 and a pair of wheels 22R (rear wheels) that support a rear portion of the travel vehicle body 11. Examples of the plurality of wheels 22 include wheeled-type wheels and crawler-type wheels (caterpillar).

The traveling device 21 is driven by the power supplied from the power unit 14. In the present example embodiment, the traveling device 21 is supplied with power from the one or plurality of electric motors 15 included in the power unit 14. Consequently, the traveling device 21 is actuated by the power generated by the one or plurality of electric motors 15. Therefore, the traveling device 21 is operable to be driven directly or indirectly by the electricity discharged from the battery 16.

As illustrated in FIG. 2, the power unit 14 includes, separately from the first motor 15a (motor for pump), at least one electric motor 15b that drives the traveling device 21. The power unit 14 includes a plurality of the electric motors 15b corresponding to respective wheels 22, and each of the wheels 22 is configured to be driven independently by a corresponding one of the electric motors 15b. Accordingly, the traveling device 21 in the present example embodiment is operable to be driven directly by the electricity discharged from the battery 16. Hereinafter, the electric motors 15b (motors for traveling) that supply power to the traveling device 21 are described as “second motors”.

Note that the wheels 22 may be driven by the power supplied from the one or plurality of electric motors 15 (for example, the first motor 15a) that supply power to other devices and instruments or by the power supplied from an engine (internal combustion engine). Although the wheels 22 are driven directly by the one or plurality of electric motors 15 in the above-described example, the power source of the traveling device 21 is not particularly limited, and the wheels 22 may be driven by a hydraulic motor or the like, which is driven by the hydraulic fluid delivered by the hydraulic pump P, and driven indirectly by the electricity discharged by the battery 16.

As illustrated in FIG. 3, the working vehicle 1 includes a steering device 23. The steering device 23 is a device that changes the steering direction and the steering angle (rudder angle) of the working vehicle 1. In the present example embodiment, the steering device 23 is supplied with the hydraulic fluid delivered by the hydraulic pump P and uses the hydraulic fluid to change the steering direction and the rudder angle. The steering device 23 includes a steering control valve 24, a steering cylinder 25, and an arm 26 (knuckle arms).

The steering control valve 24 is supplied with the hydraulic fluid delivered by the hydraulic pump P and regulates the hydraulic fluid for the steering cylinder 25. The steering control valve 24 is, for example, a three-position switching valve that is switchable by the movement of a spool or the like. The steering control valve 24 is operated by a steering handle 52 included in the operation device 51. Specifically, the steering control valve 24 is switched in accordance with the direction of rotation (steering direction) of a rotary shaft 52a (steering shaft) that is rotated by the steering handle 52.

The steering cylinder 25 is driven by the hydraulic fluid supplied from the steering control valve 24. The steering cylinder 25 extends and retracts toward one side or another side in the width direction in accordance with the switched position and the opening of the steering control valve 24.

The arm 26 is connected to the steering cylinder 25 and changes the steering (steering direction and the rudder angle) of the front wheels 22F by moving in accordance with extension/retraction of the steering cylinder 25.

As illustrated in FIG. 3, the working vehicle 1 includes a brake 27. The brake 27 is operable to perform braking of the traveling device 21. In the present example embodiment, the brake 27 is supplied with the hydraulic fluid delivered by the hydraulic pump P and is actuated by the hydraulic fluid to perform braking of the traveling device 21. The brake 27 is operable to perform braking of the pair of rear wheels 22R. The brake 27 includes a master cylinder 28 and a braking mechanism 29.

The master cylinder 28 uses the pressure of the hydraulic fluid to actuate the braking mechanism 29. The master cylinder 28, for example, pressurizes and accumulates the hydraulic fluid, which is delivered from the hydraulic pump P, in an accumulator and uses the pressure of the hydraulic fluid to actuate the braking mechanism 29. The master cylinder 28 is operated by a braking operation actuator 53 included in the operation device 51. An example of the braking operation actuator 53 is an operation actuator of a foot-pedal type or a lever type. For example, the braking operation actuator 53 of a foot-pedal type is a brake pedal, and the braking operation actuator 53 of a lever type is a parking brake. The brake pedal receives operation of the braking force of the braking mechanism 29. The parking brake receives operation to switch between a braked state in which braking is performed by the braking mechanism 29 and a released state in which the braking is released.

The braking operation actuator 53 is linked to the master cylinder 28, and the master cylinder 28 is actuated in response to operation of the braking operation actuator 53. Consequently, the master cylinder 28 actuates the braking mechanism 29 by supplying the hydraulic fluid to the braking mechanism 29 and causing the pressure of the hydraulic fluid to act.

The braking mechanism 29 is operable to perform braking of each of the pair of rear wheels 22R independently. Specifically, each of the pair of rear wheels 22R is provided with the braking mechanism 29. The braking mechanism 29 is, for example, a disk brake. The braking mechanism 29 includes a brake piston, and the brake piston is actuated to change the braking force. Specifically, the braking operation actuator 53 is operated in a braking direction to supply the hydraulic fluid from the master cylinder 28, and the brake piston is thereby caused to press a brake disk and a brake plate to increase the braking force. Meanwhile, the braking operation actuator 53 is operated in a release direction to return the hydraulic fluid to the master cylinder 28, and the brake piston is thereby caused to separate from the brake disk and the brake plate to decrease the braking force.

Note that the brake 27 is not limited to the above-described example. For example, the brake 27 may perform braking of the pair of front wheels 22F in addition to or instead of the pair of rear wheels 22R.

As illustrated in FIG. 1, the working vehicle 1 includes linkage(s) 34. The linkage 34 is provided at the travel vehicle body 11. The linkage 34 is supported to be movable in the up-down direction with respect to the travel vehicle body 11. Specifically, the linkage 34 is supported to be swingable with respect to the travel vehicle body 11 about a swing axis extending in a direction (width direction) intersecting the up-down direction. The linkage 34 allows the working device 45 to be linked thereto.

The working device 45 is a device that is linked to the travel vehicle body 11 by the linkage 34 to perform work. The working device 45 is raised and lowered in response to the linkage 34 being moved in the up-down direction by a drive actuator 36. The working device 45 is a cultivator that performs cultivation work, a ridger that performs ridging, a ditcher that performs ditching, a harvester that performs harvest of products, a mower that performs mowing of grass and the like, a tedder that performs spreading of grass and the like, a rake that performs raking of grass and the like, a baler that performs baling of grass and the like, a fertilizer spreader that spreads fertilizers, an agricultural chemical spreader that spreads agricultural chemicals, a separator that performs separation of products, and a carriage or the like that allows materials and the like to be loaded thereon.

As illustrated in FIG. 3, the working vehicle 1 includes the drive actuator 36. The drive actuator 36 is operable to raise and lower the working device 45, which is linked to the linkage 34, by moving the linkage 34 in the up-down direction.

In the present example embodiment, the drive actuator 36 is a hydraulic actuator that is driven by the hydraulic fluid delivered by the hydraulic pump P. Therefore, in the present example embodiment, the drive actuator 36 is operable to be driven indirectly by the electricity discharged from the battery 16. Note that the drive actuator 36 may be operable to be driven directly by the electricity discharged from the battery 16 and may be, for example, an electric actuator (an electric cylinder, an electric motor, or the like).

In the present example embodiment, the linkage 34 and the drive actuator 36 define at least part of a raising/lowering device 31 provided at the working vehicle 1 to raise and lower the working device 45. The raising/lowering device 31 includes, for example, a three-point linkage or the like. In the example illustrated in FIG. 1, the raising/lowering device 31 that is a three-point linkage is illustrated.

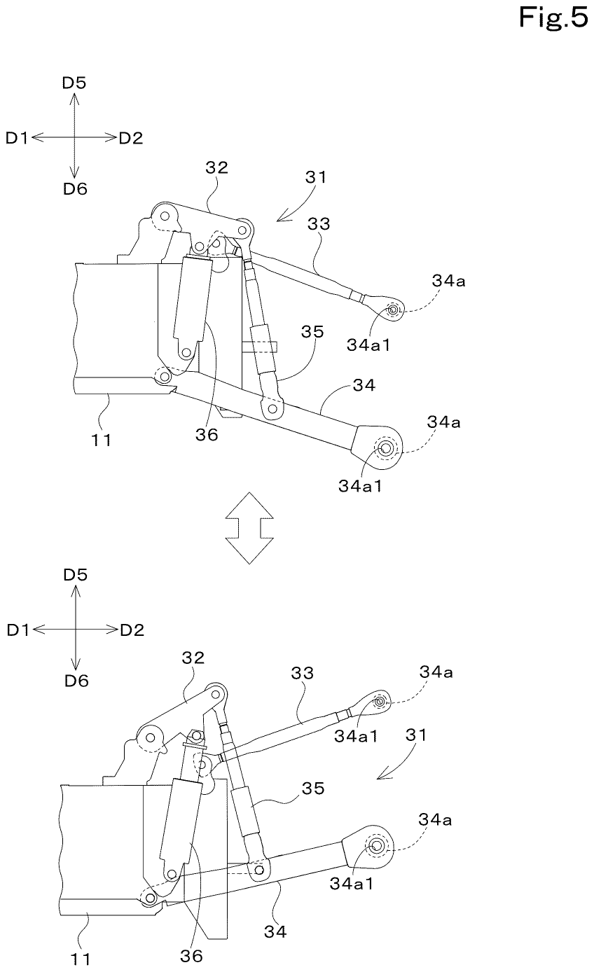

Hereinafter, the raising/lowering device 31 will be described to describe the linkage 34 and the drive actuator 36 in detail. FIG. 4 is a perspective rear view of the raising/lowering device 31. FIG. 5 is a left side view illustrating raising/lowering operation of the raising/lowering device 31. The raising/lowering device 31 is provided at a front portion and/or a rear portion of the travel vehicle body 11. In the working vehicle 1 illustrated in FIG. 1, the raising/lowering device 31 is provided at a rear portion of the travel vehicle body 11.

As illustrated in FIG. 4 and FIG. 5, the raising/lowering device 31 includes a lift arm 32, a top link 33, a lower link 34, a lift rod 35, and a lift cylinder 36. When, as in the present example embodiment, the linkage 34 and the drive actuator 36 define at least part of the raising/lowering device 31 that is a three-point linkage, the linkage 34 is the lower link 34, and the drive actuator 36 is the lift cylinder 36.

The lift arm 32 is swingable with respect to the travel vehicle body 11. The lift arm 32 is supported to be swingable in the up-down direction with respect to the travel vehicle body 11. Specifically, a front end portion of the lift arm 32 is pivotably supported at an upper portion of a rear portion of the travel vehicle body 11 to extend rearward.

The lower link 34 (linkage) is swingable with respect to the travel vehicle body 11. The lower link 34 is supported via a ball joint to be swingable in the up-down direction with respect to the travel vehicle body 11. Specifically, a front end portion of the lower link 34 is pivotably supported at a lower portion of the rear portion of the travel vehicle body 11 to extend rearward.

A rear end portion of the lower link 34 allows the working device 45 to be linked thereto. As illustrated in FIG. 4 and FIG. 5, the linkage 34 (lower link) is provided with a connector 34a (joint) that is to be connected (linked) to the working device 45 directly or indirectly. The connector 34a is provided at a rear end portion of the lower link 34. The connector 34a is connected to the working device 45 via a mount member 46. One of the connector 34a and the mount member 46 is moved with respect to the other one in a direction (direction intersecting the up-down direction in the present example embodiment), in which the axis of swing of the linkage 34 extends, such that the connector 34a and the mount member 46 are connected to each other (refer to FIG. 4). The mount member 46 is provided at, for example, the working device 45. Note that the mount member 46 may be detachably attached to the working device 45.

In the example illustrated in FIG. 4, the connector 34a is attached to the mount member 46 by being moved from one side toward the other side in the width direction. The connector 34a has an insertion hole 34a1 that is open in the width direction, and the mount member 46 (shaft member) is mounted in the insertion hole 34a1. The hole shape of the insertion hole 34a1 corresponds to the cross-sectional shape of the shaft member viewed in the axial direction. In the present example embodiment, the hole shape of the insertion hole 34a1 and the cross-sectional shape of the shaft member are substantially circular. A pin (a quick release pin, a cotter pin, or the like) is mountable on the shaft member to restrict removal of the shaft member from the insertion hole 34a1.

The connector 34a is, for example, a ball joint. The connector 34a is internally fitted to a rear end portion of the lower link 34, and the rear end portion of the lower link 34 is configured to hold the insertion hole 34a1 of the connector 34a at least in a direction intersecting the up-down direction. The rear end portion of the lower link 34 holds the insertion hole 34a1 of the connector 34a such that the direction of opening of the insertion hole 34a1 is allowed to be changed.

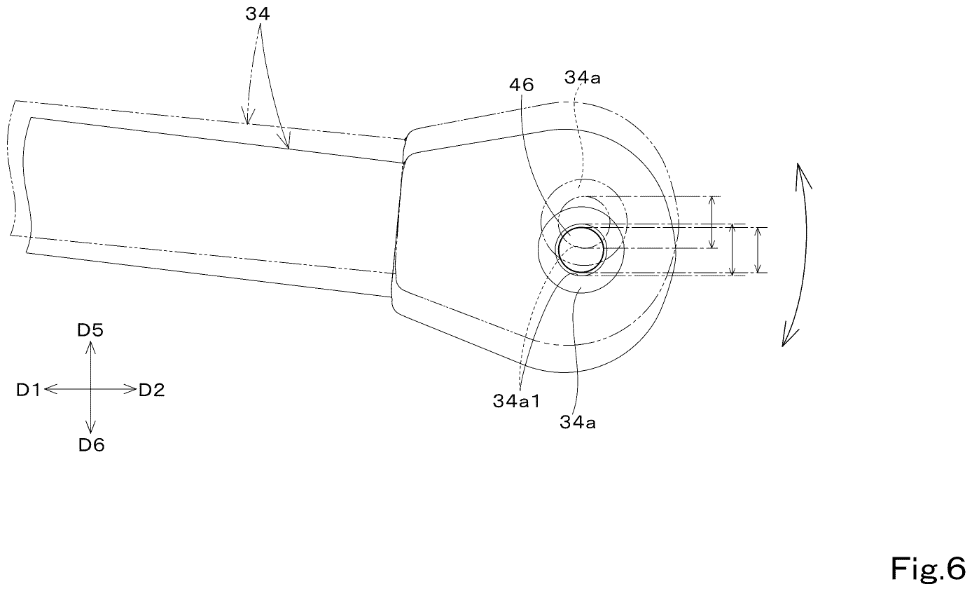

Therefore, to link the working device 45 to the raising/lowering device 31, alignment between the connector 34a and the mount member 46 is performed to mount the connector 34a (shaft member) on the mount member 46. FIG. 6 illustrates alignment between the connector 34a and the mount member 46.

As illustrated in FIG. 6, when the insertion hole 34a1 and the shaft member coincide with each other in terms of position (position in the up-down direction and the front-rear direction in the present example embodiment) in a direction orthogonal to the axial direction of the shaft member, the shaft member is enabled to be inserted into the insertion hole 34a1. Consequently, the shaft member is inserted into the insertion hole 34a1 and mounted in the insertion hole 34a1, and the working device 45 is thereby linked to the linkage 34. Note that, in FIG. 6, the solid lines indicate a state in which the position of the insertion hole 34a1 and the position of the shaft member coincide with each other, and the dashed double-dotted lines indicate a state in which the position of the insertion hole 34a1 and the position of the shaft member do not coincide with each other.

Note that, although a ball joint has been described as an example of the connector 34a in the above description, the connector 34a is not limited to a ball joint. For example, the connector 34a may be a hole (insertion hole) formed in the lower link 34 (linkage) to extend in the swing axis direction (width direction) of the lower link 34 or may be a collar in which the insertion hole is formed.

The connector 34a may be attachable to and detachable from the lower link 34. When the connector 34a is a ball joint, a rear end portion of the lower link 34 includes, for example, a quick hitch that holds the ball joint such that the ball joint is detachable and attachable.

The lift rod 35 links the lift arm 32 and the lower link 34 to each other. An upper end portion of the lift rod 35 is connected to a rear end portion of the lift arm 32. A lower end portion of the lift rod 35 is connected to an intermediate portion of the lower link 34 in the length direction. Therefore, the lower link 34 linked to the lift arm 32 via the lift rod 35 is raised and lowered in response to the lift arm 32 being raised and lowered.

The top link 33 is swingable with respect to the travel vehicle body 11. The top link 33 is supported via the ball joint to be swingable in the up-down direction with respect to the travel vehicle body 11. Specifically, a front end portion of the top link 33 is pivotably supported at an upper portion of the rear portion of the travel vehicle body 11 to extend rearward.

A rear end portion of the top link 33 allows the working device 45 to be linked thereto. As with the lower link 34, the top link 33 is also provided with a connector that is to be connected (linked) to the working device 45 directly or indirectly. For the connector 34a of the top link 33, the same configuration as the above-described configuration of the connector 34a of the lower link 34 is usable, and detailed description thereof is thus omitted.

With the above configuration, by linking the working device 45 to the rear end portion of the top link 33 and to the rear end portion of the lower link 34, the working device 45 is linked to the working vehicle 1 such that the working device 45 can be raised and lowered.

As illustrated in FIG. 3, the lift cylinder 36 (drive actuator) is a hydraulic cylinder that is operated by the hydraulic fluid delivered from the hydraulic pump P. The lift cylinder 36 has one end portion pivotably supported at the lift arm 32 and another end portion pivotably supported at a rear portion of the travel vehicle body 11. As illustrated in FIG. 3, the lift cylinder 36 is a single-acting cylinder.

Therefore, when the hydraulic fluid is supplied to a bottom fluid chamber of the lift cylinder 36, the lift cylinder 36 extends. Meanwhile, when the hydraulic fluid is discharged from the bottom fluid chamber, the lift cylinder 36 retracts. Consequently, the lift arm 32 is caused to swing in the up-down direction by the lift cylinder 36 driven to extend and retract. With the above configuration, the lift cylinder 36 (drive actuator) indirectly causes the lower link 34 (linkage) to move (swing) in the up-down direction by moving the lift arm 32 in the up-down direction.

As illustrated in FIG. 3, the working vehicle 1 includes a control valve 37 to control the drive actuator 36. The control valve 37 is connected to the hydraulic pump P and regulates the hydraulic fluid that is to be supplied from the hydraulic pump P to the drive actuator 36. The control valve 37 is, for example, a three-position switching valve that is switchable by the movement of a spool or the like. The control valve 37 is switchable among a neutral position, a first position, and a second position.

The control valve 37 in the neutral position with the opening thereof set to zero shuts off supply of the hydraulic fluid from the hydraulic pump P to the lift cylinder 36 and discharge of the hydraulic fluid from the lift cylinder 36. The control valve 37 in the first position is operable to cause the hydraulic fluid delivered by the hydraulic pump P to be supplied to the bottom fluid chamber by changing the opening of the control valve 37. The control valve 37 in the second position is operable to cause the hydraulic fluid in the bottom fluid chamber to be discharged to a hydraulic-fluid tank T by changing the opening of the control valve 37.

Therefore, the lift cylinder 36 does not extend and retract and keeps the length thereof when the control valve 37 is in the neutral position. The lift cylinder 36 extends when the control valve 37 is in the first position, and the lift cylinder 36 retracts when the control valve 37 is in the second position. In the present example embodiment, the spool of the control valve 37 is provided with an operated portion 37a that is to be operated by a manual operator 54 included in the operation device 51. The operated portion 37a is operated by the manual operator 54 to change the position of the spool to a neutral position, a first position, or a second position.

The manual operator 54 receives operation to cause the drive actuator 36 to move the linkage 34 in the up-down direction. The manual operator 54 is operable to be tilted and is, for example, a raising/lowering lever (position lever) that receives operation of the position of the raising/lowering device 31 (linkage 34) in the up-down direction. The manual operator 54 receives operation (operation to raise the raising/lowering device 31) to upwardly move the linkage 34 by being operated to swing in a first direction (rearward and upward in the present example embodiment). The manual operator 54 receives operation (operation to lower the raising/lowering device 31) to move the linkage 34 downwardly by being operated to swing in a second direction (forward and downward in the present example embodiment) opposite to the first direction. Note that the manual operator 54 is not limited to a lever-shaped member that receives swinging operation. For example, the manual operator 54 may include a handle-shaped member or the like to receive raising/lowering operation performed by an operator.

As illustrated in FIG. 3, the manual operator 54 in the present example embodiment is linked to the operated portion 37a via a first link mechanism 38a. Consequently, in response to the manual operator 54 being operated to swing, the first link mechanism 38a is actuated to act on the operated portion 37a and can switch the switched position of the control valve 37 from the neutral position to the first position or the second position. Consequently, the drive actuator 36 is operable to be controlled by a manual operation of the manual operator 54.

A feedback lever 38b is linked to the first link mechanism 38a. The feedback lever 38b is linked to the lift arm 32 via a second link mechanism 38c. Therefore, when operation of the manual operator 54 causes the lift cylinder 36 to extend and retract and the lift arm 32 to swing in the up-down direction, the control valve 37 is moved via the second link mechanism 38c, the feedback lever 38b, and the first link mechanism 38a to the neutral position. Therefore, when the manual operator 54 is operated to cause the lift arm 32 to swing in the up-down direction, the position of the lift arm 32 can be kept at a position corresponding to an operated position of the manual operator 54. Consequently, an operator can change the height of the linkage 34 (lower link) in accordance with an operation amount of the manual operator 54.

The working vehicle 1 includes an output shaft 41 (PTO shaft). The output shaft 41 transmits a rotational driving force to the working device 45 linked to the linkage 34. The output shaft 41 is located in the vicinity of the linkage 34 in the travel vehicle body 11. In the present example embodiment, the output shaft 41 is provided to protrude rearward from a rear portion of the travel vehicle body 11. When the linkage 34 (raising/lowering device 31) is provided at a front portion of the travel vehicle body 11, the output shaft 41 may be provided to protrude forward from the front portion of the travel vehicle body 11 and is provided at least one of forward and rearward of the travel vehicle body 11.

The output shaft 41 is linked to an input shaft of the working device 45 via a linkage member, such as a universal joint or the like. Consequently, the working device 45 can be driven by the rotational driving force transmitted from the output shaft 41. In the present example embodiment, the output shaft 41 is driven by the power supplied from the power unit 14. Therefore, in the present example embodiment, the working device 45, to which the rotational driving force is transmitted from the output shaft 41, is operable to be indirectly driven by the electricity discharged from the battery 16.

As illustrated in FIG. 2, the power unit 14 includes, separately from the electric motors 15 that drive the hydraulic pump P or the traveling device 21, an electric motor 15c that drives the output shaft 41. Therefore, the output shaft 41 can be driven independently from the hydraulic pump P and the traveling device 21. Hereinafter, the electric motor 15c (e.g., the motor for PTO) that supplies power to the output shaft 41 will be described as a “third motor”.

Note that, although the working device 45 that is driven by the rotational driving force transmitted from the output shaft 41 has been described in the above description, the working device 45 may be driven by the hydraulic fluid delivered by the hydraulic pump P separately from the output shaft 41. In such a case, the working device 45 includes a hydraulic actuator (a hydraulic cylinder, a hydraulic motor, or the like) that is driven by the hydraulic fluid, and the hydraulic actuator is driven via a switch valve 42, which is provided at the working vehicle 1, by the hydraulic fluid supplied from the hydraulic pump P. The switch valve 42 is, for example, an electromagnetic proportional valve and can regulate, by changing the opening thereof, the hydraulic fluid that is to be supplied to the hydraulic actuator.

The working device 45 may be driven directly by the electricity discharged from the battery 16. In such a case, the working device 45 includes an electric actuator (an electric motor, an electric cylinder, or the like) that is driven by the electricity supplied from the battery 16, and the electric actuator is driven by the electricity supplied from the battery 16 via an inverter 17 and a cable. Further, the working device 45 may be driven by the power supplied from an engine (internal combustion engine) that supplies power to other devices and instruments.

Hereinafter, devices, instruments, and the like mounted on the working vehicle 1 will be described with FIG. 2 mainly. As illustrated in FIG. 2, the working vehicle 1 includes a controller 71. The working vehicle 1 includes a storing device (memory and/or storage) 72.

The controller 71 includes one or a plurality of processors. The controller 71 is a controller for the working vehicle 1 and is configured or programmed to perform various controls relating to the working vehicle 1. The controller 71 is connected through an in-vehicle network, such as CAN, ISOBUS, LIN, FlexRay, and/or the like, to devices and instruments mounted on the working vehicle 1 communicably with the devices and the instruments. Therefore, the controller 71 is configured or programmed to control the devices and the instruments.

The controller 71 includes one or a plurality of memories, various types of analog circuits, various types of digital circuits, and the like. The one or plurality of memories save (store) at a software program, which is to be executed by the one or plurality of processors, and various types of data. The controller 71 can read out the software program from the one or plurality of memories by the one or plurality of processors and perform various types of processing based on the software program. Note that the controller 71 may be configured or programmed to perform various types of processing based on a predetermined logical circuit by the one or plurality of processors.

The processors may include, for example, a central processing unit (CPU), a graphics processing unit (GPU), a digital signal processor (DSP\hat{ }), a field programmable gate array (FPGA), an application specific integrated circuit (ASIC), and the like.

Note that the configuration of the controller 71 is not limited to the above-described configuration, and the controller 71 may be configured such that a plurality of processors physically separated from each other cooperate with each other to perform various types of processing. In such a case, the plurality of processors are each mounted on one or a plurality of computers physically separated from the working vehicle 1, and these processors are connected such that communication is enabled by a network, such as an in-vehicle network, a LAN, a WAN, the internet, or the like.

The software program may be saved in the storing device 72 that is connected such that communication is enabled or an external server that is connected via the aforementioned network to the controller 71, and software programs may be installed into the aforementioned one or plurality of memories from these devices.

The storing device 72 is a device to store information. The storing device 72 is a nonvolatile memory, such as a HDD, a SSD, a CD-ROM, a DVD-ROM, or the like. The storing device 72 is connected to the controller 71 communicably with the controller 71, and the controller 71 causes the storing device 72 to store various types of information and acquires information stored in the storing device 72.

The controller 71 is configured or programmed to change the power that is to be generated by the power unit 14 by controlling the power unit 14. The controller 71 in the present example embodiment is configured or programmed to control the rotational speed and the direction of rotation of each electric motor 15 by controlling the inverter 17. For example, the controller 71 can control the output (the delivery amount of the hydraulic fluid) of the hydraulic pump P by controlling the rotational speed of the first motor 15a. Therefore, the controller 71 is configured or programmed to control the driven speed of the drive actuator 36 by controlling the output of the hydraulic pump P.

The controller 71 can control the rotational driving (the rotational speed, the direction of rotation, and the like) of the output shaft 41 by controlling the rotational speed and the direction of rotation of the third motor 15c. Consequently, the controller 71 is configured or programmed to control driving of the working device 45 linked to the linkage 34 and to which the power is supplied from the output shaft 41.

Note that, although the controller 71 that controls the inverter 17 to control the output of the hydraulic pump P and the rotational driving of the output shaft 41 has been described in the above-described example, the controller 71 may be configured or programmed to control devices and instruments without depending on the control of the power unit 14 by the inverter 17. Specifically, when the hydraulic pump P is a variable displacement hydraulic pump, the controller 71 controls a piston, which changes the angle of the swash plate of the hydraulic pump P, to change the angle of the swash plate, thus controlling the output of the hydraulic pump P.

When the working device 45 includes the hydraulic actuator, the controller 71 controls the switch valve 42 to regulate the hydraulic fluid that is to be supplied to the hydraulic actuator, thereby controlling driving of the working device 45. When the working device 45 includes the electric actuator, the controller 71 controls the inverter 17 to control driving of the electric actuator. Consequently, the controller 71 is configured or programmed to control driving of the working device 45 linked to the linkage 34.

Further, the controller 71 is configured or programmed to control the drive actuator 36. As illustrated in FIG. 2 and FIG. 3, the working vehicle 1 includes a drive unit 55 that operates the manual operator 54 by being driven. The controller 71 controls the drive unit 55 to control the drive actuator 36 indirectly. The drive unit 55 is linked to the manual operator 54 and performs operation to swing the manual operator 54 by being controlled by the controller 71. The controller 71 outputs an instruction signal to the drive unit 55. Based on the instruction signal output from the controller 71, the drive unit 55 operates the manual operator 54 to swing by a predetermined operation amount.

The drive unit 55 includes an electric actuator 55a and is driven by an instruction signal output from the controller 71. The electric actuator 55a of the drive unit 55 is, for example, an electric cylinder. One end of the electric cylinder 55a is linked to the manual operator 54, and the manual operator 54 is operated to swing in response to the electric cylinder 55a extending and retracting. Therefore, the controller 71 outputs an instruction signal to a servo amplifier included in the drive unit 55, and the servo amplifier supplies electricity to the electric cylinder 55a. Consequently, the electric cylinder 55a extends and retracts to cause the drive unit 55 to operate the manual operator 54 to swing a predetermined operation amount.

Note that the electric actuator 55a of the drive unit 55 is not limited to an electric cylinder and may be, for example, a servo motor or the like.

As illustrated in FIG. 2, the working vehicle 1 includes a detector 81. The detector 81 is a device that detects a state of the working vehicle 1 and outputs a result of the detection as a detection signal. The detector 81 is connected to the controller 71 in a wired or wireless manner communicably with the controller 71 and outputs results of detection to the controller 71. The controller 71 can acquire a state of the working vehicle 1 by acquiring a result of detection performed by the detector 81. The detector 81 includes, for example, a battery detector 82, a rotation detector 83, a steering detector 84, a raising/lowering detector 85, and the like.

The battery detector 82 is a device that detects a state of the battery 16. The battery detector 82 is a battery management unit (BMU) provided at the battery 16. The battery detector 82 detects temperature, voltage, electric current, terminal voltage and/or the like of a cell inside thereof, or the like of the battery 16. For example, the battery detector 82 detects the terminal voltage of the cell inside of the battery 16 and detects, by a voltage measuring method, a remaining charge level (charging rate) of the battery 16. Note that the method of detecting the remaining charge level of the battery 16 is not limited to the voltage measuring method and may be another method such as a Coulomb counter method, a battery-cell modelling method, an impedance track method, or the like.

The rotation detector 83 is a device that detects rotation of the power of the power unit 14. The rotation detector 83 is, for example, an optical or magnetic rotation sensor. The rotation detector 83 detects rotation of any portion in a power transmission path extending from the motor shaft of each electric motor 15 to a power supply target. The rotation detector 83 outputs a signal (detection signal) of a detected rotational speed and a detected rotational direction to the controller 71. The controller 71 can acquire the rotational speed and the rotational direction of each electric motor 15 based on a result of detection by the rotation detector 83, a predetermined arithmetic expression previously stored in the storing device 72, and/or the like. The controller 71 can calculate the vehicle speed of the travel vehicle body 11 by acquiring the rotational speed and the rotational direction of the electric motor 15 that outputs power to the traveling device 21.

The steering detector 84 is a device that detects the steering direction and the steering angle (rudder angle) of the steering device 23. The steering detector 84 is, for example, an optical or magnetic rotation sensor. The steering detector 84 detects the rotation angle and the rotational direction of a steering shaft 52a. The steering detector 84 outputs a signal (detection signal) of a detected rotation angle and a detected rotational direction to the controller 71. The controller 71 can acquire the steering direction and the steering angle of the steering device 23 based on a result of detection by the steering detector 84, a predetermined arithmetic expression previously stored in the storing device 72, and/or the like. Hereinafter, description will be provided based on that the steering angle is zero when the tractor 1 travels straight (during straight travelling) and is the absolute value of a difference with respect to a steering angle during straight traveling unless otherwise specified.

The raising/lowering detector 85 is a device that detects raising/lowering of the raising/lowering device 31. In the present example embodiment, the raising/lowering detector 85 is a sensor (lift arm sensor) that detects the angle of the lift arm 32. The raising/lowering detector 85 is, for example, a rotary displacement variable resistor, such as a potentiometer. The controller 71 can calculate a position AP of the linkage 34 in the up-down direction based on a result of detection by the raising/lowering detector 85, a predetermined arithmetic expression previously stored in the storing device 72, and/or the like.

In the present example embodiment, the position AP of the linkage 34 in the up-down direction is the height of a rear end portion of the linkage 34 with respect to the travel vehicle body 11. In detail, the position AP in the up-down direction is the height of the center of the insertion hole 34a1. Hereinafter, the position AP of the linkage 34 in the up-down direction, the position AP being acquired by the controller 71 based on a result of detection by the raising/lowering detector 85, may be referred to as “actual position” for convenience of description.

Note that, although an example in which the controller 71 calculates as the actual position AP the height of the linkage 34 will be described in the following description, the angle of the linkage 34 may be calculated as the actual position AP.

The above-described detector 81 is one example, and the type of the sensor is not limited thereto. The raising/lowering detector 85 may be, for example, a lift cylinder sensor that detects, instead of the angle of the lift arm 32, the extension (stroke) of the lift cylinder 36. The raising/lowering detector 85 may be a rotation sensor that detects the angle of the lower link 34.

Further, the above-described detector 81 is one example, and the detector described above is not the only detector. Addition, deletion, or change may be performed, as appropriate, in accordance with the function of the working vehicle 1.

For example, as illustrated in FIG. 2, the detector 81 may include a sensor 86. The sensor 86 is a device that senses an environment around the working vehicle 1. The controller 71 can detect an operator, an obstacle, and the like around the working vehicle 1 based on a result of sensing by the sensor 86 and can estimate the position of the working vehicle 1 based on a result (data of a detection point group) of sensing and environmental map information that is stored in the storing device 72 or the like. The controller 71 can estimate a specific position VP (for example, the central position in the front-rear direction and the width direction) on the travel vehicle body 11 and/or a specific position VP on the working device 45 linked to the linkage 34 based on a result of sensing. Hereinafter, the specific position VP estimated based on a result of sensing by the sensor 86 will be described as “estimated position”.

The sensor 86 includes an optical distance measuring sensor, a signal processing circuit, and the like. An example of the optical distance measuring sensor of the sensor 86 is, for example, a light detection and ranging (LiDAR).

The LiDAR (laser sensor) emits pulsed measurement light (laser light) millions of times per second from a light source such as a laser diode or the like, performs scanning in the horizontal direction or the vertical direction by reflecting the measurement light by a rotary mirror, and projects the light onto a predetermined detection range (sensing range, for example, 360°). Then, the LiDAR receives, with a light-receiving element, reflected light of the measurement light reflected by an object. Based on a period of time from when the measurement light is emitted by the LiDAR to when the reflected light is received, the signal processing circuit detects (time of flight (ToF) method) the distance to the object.

Note that examples of the optical distance measuring sensor of the sensor 86 include, in addition to the LiDAR, imaging devices, such as a CCD camera on which a charge coupled device (CCD) image sensor is mounted, a CMOS camera on which a complementary metal oxide semiconductor (CMOS) is mounted, and the like, and a ToF camera. Although the sensor 86 includes the optical distance measuring sensor in the example described above, a sonic distance measuring sensor (for example, an aerial ultrasonic sensor, such as a sonar) may be used instead of the optical distance measuring sensor.

As illustrated in FIG. 2, the detector 81 may include a position detector 87. The position detector 87 is a device that performs positioning (positional detection of the working vehicle 1) of the working vehicle 1. The position detector 87 receives a satellite signal from a satellite positioning system through a GPS antenna and, based on the satellite signal, performs positioning of the working vehicle 1. The position detector 87 can perform, as positioning of the working vehicle 1, positioning of the specific position VP (for example, the central position in the front-rear direction and the width direction) on the travel vehicle body 11 and/or the specific position VP on the working device 45 linked to the linkage 34. Hereinafter, the aforementioned specific position VP positioned by the position detector 87 will be described as “positioned position”.

As illustrated in FIG. 2, the detector 81 may include a posture detector 88. The posture detector 88 is a device that detects an orientation of the working vehicle 1 (travel vehicle body 11). The posture detector 88 detects, as the orientation of the travel vehicle body 11, a three-dimensional inertial motion of the travel vehicle body 11. The posture detector 88 is, for example, an inertial measurement unit (IMU) including an acceleration sensor, a gyroscope sensor, and/or the like. The posture detector 88 detects information on inclination (the roll angle, the pitch angle, and the yaw angle) and/or the like of the travel vehicle body 11. Note that the following description will be provided based on that each of the roll angle and the pitch angle when the travel vehicle body 11 is in a horizontal orientation is zero and that each of the roll angle and the pitch angle is the absolute value of a difference with respect to the horizontal orientation unless otherwise specified.

As illustrated in FIG. 2, the operation device 51 may include, not limited to the steering handle 52, the braking operation actuator 53, and the like that are described above, an operation actuator 62 (input operation actuator) that receives operation and outputs the received operation as a signal (operation signal) to the controller 71, and the controller 71 may be configured or programmed to control devices and instruments in accordance with operation of the operation actuator. The input operation actuator 62 is connected to the controller 71 in a wired or wireless manner communicably with the controller 71 and outputs operation signals to the controller 71. The controller 71 is configured or programmed to control devices and instruments based on operation signals output from the input operation actuator 62. Examples of the input operation actuator 62 are an acceleration operation actuator 63, a rotation operation actuator 64, and the like.

The acceleration operation actuator 63 is an operation actuator that receives operation of the propelling force of the traveling device 21. The acceleration operation actuator 63 includes, for example, an accelerator pedal, an accelerator lever, and/or the like, and a sensor detects operation (the operation direction, the operation amount, and/or the like) thereof and outputs the operation as an operation signal to the controller 71. Upon acquiring the operation signal from the acceleration operation actuator 63, the controller 71 controls the power unit 14 (second motors 15b) based on the operation signal, a result of detection by the rotation detector 83, an arithmetic expression, and/or the like.

The rotation operation actuator 64 is an operation actuator that receives operation of the rotational speed of the output shaft 41. The rotation operation actuator 64 includes, for example, a dial and/or the like, and a sensor detects operation (the operation direction, the operation amount, and/or the like) thereof and outputs the operation as an operation signal to the controller 71. Upon acquiring the operation signal from the rotation operation actuator 64, the controller 71 controls the power unit 14 (third motor 15c) based on the operation signal, a result of detection by the rotation detector 83, an arithmetic expression, and/or the like.

Note that the operation device 51 may include an operation actuator other than the acceleration operation actuator 63 and the rotation operation actuator 64 and may include, for example, an operation actuator (pump operation actuator) that receives operation of the rotational speed of the electric motor 15a (first motor) that supplies power to the hydraulic pump P. When the operation device 51 does not include the pump operation actuator, the controller 71 controls the rotational speed of the electric motor 15, which supplies power to the hydraulic pump P, to be a rated rotational speed based on a result of detection by the rotation detector 83.

Although the working vehicle 1 that operates by being operated by the operation device 51 has been described in the above description, the working vehicle 1 may operate, separately from the operation device 51, by receiving operational information or information of an instruction. In such a case, the working vehicle 1 includes a communicator 66 that receives operational information or information of an instruction. The communicator 66 is a communication interface of the working vehicle 1 and includes a communication circuit. The communicator 66 wirelessly communicates with an external server, a portable terminal, a remote operation device, and/or the like through, for example, wireless fidelity (Wi-Fi; registered trademark) of IEEE802.11 series, which is a telecommunication standard, a mobile communication network, a data communication network, and/or the like. The communicator 66 wirelessly communicates with a server and/or the like and receives various types of information, data, signals, and/or the like. The communicator 66 may also function as an output interface to output (transmit) various types of information, data, signals, and/or the like to a server and/or the like.

Note that, in the following description, an operation actuator that, similarly to the input operation actuator 62 described above, receives an instruction for operation from an operator and outputs the instruction for the operation (operational information) to the controller 71, a device 61 that, similarly to the communicator 66, receives operational information and information of an instruction from the outside, and the like may be referred to as “input interface”. The input interface 61 receives an input of information and outputs the information for which the input is received to the controller 71.

The controller 71 is configured or programmed to perform vibration control to control the drive actuator 36 to vibrate the linkage 34. That is, since the working vehicle 1 includes the manual operator 54 that receives manual operation in the present example embodiment, the controller 71 is configured or programmed to perform vibration control separately from manual operation.

The working vehicle 1 includes the input interface 61 that receives an instruction to perform vibration control. Upon receipt of the instruction by the input interface 61, the controller 71 performs the vibration control instead of control by the manual operation. For example, the input interface 61 that receives an instruction to perform vibration control is the input operation actuator 62 (instruction operation actuator 65) that receives operation of the instruction. Upon receipt of the operation of the instruction to perform the vibration control, the instruction operation actuator 65 outputs an operation signal of the instruction to the controller 71. When the operation signal of the instruction is output, the controller 71 starts performing the vibration control.

The instruction operation actuator 65 is a hardware-type operation actuator, such as a physical switch or the like. Examples of the instruction operation actuator 65 are a push button switch, a seesaw switch, and the like. The instruction operation actuator 65 is provided, for example, inside or outside the protecting mechanism 13. For example, the instruction operation actuator 65 is provided, as inside the protecting mechanism 13, around the operator's seat 12. The instruction operation actuator 65 may be provided, as outside the protecting mechanism 13, in the vicinity (for example, at a rear fender) of the raising/lowering device 31.

Note that the instruction operation actuator 65 may be provided at a remote controller that is detachable from the working vehicle 1, and the remote controller is connected to the controller 71 in a wired or wireless manner communicably with the controller 71. In such a case, the remote controller is connected to the controller 71 via the communicator 66 communicably with the controller 71.

When the working vehicle 1 includes a display, the instruction operation actuator 65 may be of a software type such as a display image that is displayed on a screen of the display so as to be operable. When the working vehicle 1 includes the communicator 66 as the input interface 61, operation of the vibration control may be received by a portable terminal or the like communicable with the communicator 66.

In the vibration control, the controller 71 causes the linkage 34 to vibrate from one side toward another side and from the other side to the one side in the up-down direction such that a specific position (reference position BP) is the center of an amplitude α. In the vibration control, the controller 71 causes the linkage 34 to vibrate such that the position (reference position BP) of the linkage 34 in the up-down direction at the time when the vibration control is started is the center of the amplitude α. The amplitude α mentioned here means a peak-to-peak amplitude of the center of the insertion hole 34a1 in the vibration control.

Upon receipt of an operation signal of an instruction to perform vibration control from the instruction operation actuator 65, the controller 71 acquires, as the reference position BP, a result of detection by the raising/lowering detector 85 and keeps the reference position BP in a memory. Each time when the input interface 61 receives an input of an instruction to perform vibration control, the controller 71 updates the reference position BP kept in the memory.

Note that the reference position BP is not limited to the position of the linkage 34 in the up-down direction at the time when vibration control is started. For example, the reference position BP may be previously kept (stored) in a memory or the storing device 72, and the controller 71 may refer to the reference position BP to perform vibration control. Specifically, the storing device 72 may store a first table in which the reference position BP is associated with each working device 45 that is to be linked to the linkage 34. In the first table, identification information indicating the working device 45 and the reference position BP are stored in association with each other.

The controller 71 acquires identification information that has been input via the input interface 61 and acquires the reference position BP associated with the identification information from the first table. The controller 71 keeps the reference position BP acquired from the first table in a memory. For example, when the input interface 61 is the communicator 66, operation to select the working device 45 attached to the linkage 34 is received by a portable terminal or the like communicable with the communicator 66, and the communicator 66 receives identification information. When a transmitter (for example, a beacon) that is attached to each working device 45 and that transmits identification information is mounted, the controller 71 may specify the working device 45 attached to the linkage 34 based on identification information received by the input interface 61 (a receiver or a beacon scanner) from the beacon.

The reference position BP may be associated with, instead of or in addition to the working device 45, positional information. In such a case, the storing device 72 may store a second table in which the reference position BP is associated with positional information of each location. An example of the positional information is the position of a barn or an agricultural field H. For example, when the working vehicle 1 includes the position detector 87, the controller 71 acquires a positioned position positioned by the position detector 87 and refers to the second table to acquire the reference position BP associated with the positioned position. When the working vehicle 1 includes the sensor 86, the controller 71 acquires an estimated position estimated based on a result of sensing by the sensor 86 and refers to the second table to acquire the reference position BP associated with the estimated position. The controller 71 keeps the reference position BP acquired from the second table in a memory.

Note that the first and second tables described above are merely examples. The storing device 72 may store a third table in which the reference position BP is associated with each working device 45 and with each piece of positional information, and the controller 71 may acquire the reference position BP from the third table.

The controller 71 controls the drive actuator 36 such that the reference position BP kept in the memory is the center of the amplitude α based on a result of detection by the raising/lowering detector 85 and the predetermined amplitude α stored in the storing device 72. The amplitude α is defined by, for example, a value of 20 mm to 60 mm or the like. Note that the amplitude α stored in the storing device 72 may be editable, as appropriate, based on information for which an input is received by the input interface 61 (the input operation actuator 62, the communicator 66, and/or the like).

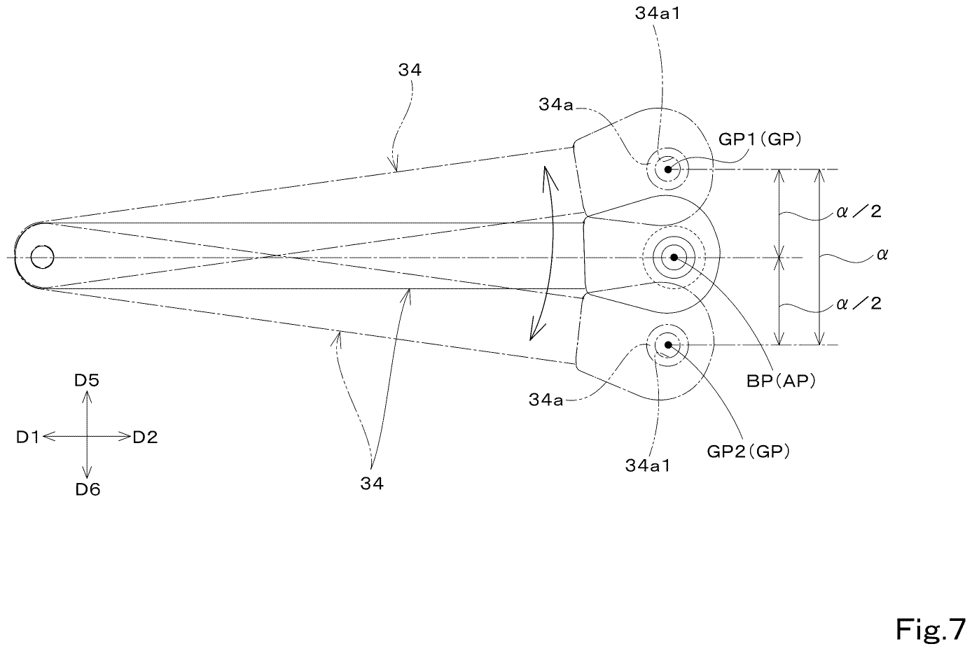

FIG. 7 illustrates operation of the linkage 34 in vibration control. As illustrated in FIG. 7, the controller 71 controls the drive actuator 36 to move the linkage 34 toward one side in the up-down direction and, when the linkage 34 reaches a maximum deviation (the uppermost point or the lowermost point) of the amplitude α, move the linkage 34 toward another side in the up-down direction. Specifically, the controller 71 causes the linkage 34 to move upward and, when the linkage 34 reaches the maximum deviation (the uppermost point) of the amplitude α, causes the linkage 34 to move downward. The controller 71 causes the linkage 34 to move downward and, when the linkage 34 reaches the maximum deviation (the lowermost point) of the amplitude α, causes the linkage 34 to move upward. The controller 71 controls the drive actuator 36 to repeatedly perform the up-down movement of the linkage 34 to vibrate the linkage 34.

For example, to move (swing) the linkage 34 upwardly in vibration control, the controller 71 controls the drive actuator 36 such that a difference ΔD between the actual position AP and a target position GP (first target position GP1), which is higher by a peak amplitude α/2 than the reference position BP, is zero. That is, in the present example embodiment, the controller 71 controls the drive unit 55 to operate the manual operator 54 in the first direction, thereby switching the control valve 37 to the first position and raising the linkage 34 to the first target position GP1.

To move (swing) the linkage 34 downwardly in vibration control, the controller 71 controls the drive actuator 36 such that the difference ΔD between the actual position AP and the target position GP (second target position GP2), which is lower by the peak amplitude α/2 than the reference position BP, is zero. That is, in the present example embodiment, the controller 71 controls the drive unit 55 to operate the manual operator 54 in the second direction, thereby switching the control valve 37 to the second position and lowering the linkage 34 to the second target position GP2.

Upon starting vibration control, the controller 71 counts the number of vibrations since the start of the vibration control. The number of vibrations is, for example, the number of reciprocations of the linkage 34 in the up-down direction. The controller 71 continues the vibration control until the number of vibrations reaches a predetermined number of times. When the number of vibrations since the start of the vibration control reaches the predetermined number of times, the controller 71 terminates the vibration control.

Note that the controller 71 may terminate the vibration control based on a condition other than the number of vibrations. For example, upon starting vibration control, the controller 71 counts an elapsed time since the start of the vibration control. The controller 71 continues the vibration control until the elapsed time exceeds a predetermined time. When the predetermined time has elapsed since the start of the vibration control, the controller 71 terminates the vibration control.

When the input interface 61 is operable to receive an input of an instruction to terminate vibration control, the controller 71 may terminate vibration control when the input interface 61 receives an input of a termination instruction. For example, the instruction operation actuator 65 receives operation of a termination instruction by being operated again after receiving operation of an instruction to perform vibration control and outputting an operation signal of the instruction to the controller 71. Along with this, the instruction operation actuator 65 outputs an operation signal of the termination instruction to the controller 71. When the operation signal of the termination instruction is output, the controller 71 terminates performing vibration control. Further, the instruction operation actuator 65 may include a start operation actuator that receives operation of an instruction to perform vibration control and a termination operation actuator that receives operation of a termination instruction.

The controller 71 may correct the reference position BP in accordance with a load that acts on the linkage 34 in the up-down direction during a period from the start to the termination of the vibration control. For example, the controller 71 corrects the reference position BP in accordance with a downward load that acts on the linkage 34. Specifically, during a period in which the vibration control is performed, the controller 71 determines whether a downward load acting on the linkage 34 is relatively large based on the amount of change per hour in the difference ΔD between the first target position GP1 and the actual position AP.

More specifically, the controller 71 causes the linkage 34 to move (swing) upward in the vibration control and determines that a downward load acting on the linkage 34 is relatively large when, for example, the difference ΔD between the first target position GP1 and the actual position AP does not change for a predetermined time (determination time) or longer. In such a case, the controller 71 corrects the reference position BP by a set height. The determination time and the set height are previously stored in the storing device 72 and may be editable, as appropriate, based on information for which an input is received by the input interface 61 (the input operation actuator 62, the communicator 66, and/or the like). The set height may be defined such that the set height increases in accordance with an elapse of time.

However, the method of determining the degree of the load acting on the linkage 34 in the up-down direction is not limited to the example described above. For example, when the drive actuator 36 is a hydraulic cylinder, a pressure sensor may be provided in a fluid passage connecting the drive actuator 36 and the control valve 37 to each other, and the controller 71 may determine the degree of the load acting on the linkage 34 in the up-down direction based on a result of detection by the pressure sensor. The controller 71 may determine the degree of the load acting on the linkage 34 during a period in which the linkage 34 is moved upward first time after the start of the vibration control.

As described above, the controller 71 can cause the linkage 34 to vibrate with the peak amplitude α/2 such that the reference position BP is the center of the peak-to-peak amplitude α.

The vibration control may include first vibration control and second vibration control. The first vibration control is control to cause vibration to remove adhering substances, such as soil, snow, water droplets, and the like, adhering to the working device 45. The second vibration control is control to perform alignment between the linkage 34 (connector 34a) and the working device 45 (mount member 46). The controller 71 can perform at least one of the first vibration control and the second vibration control.

When the controller 71 is configured or programmed to perform both of the first vibration control and the second vibration control, the controller 71 is configured or programmed to selectively perform the first vibration control or the second vibration control as the vibration control. In such a case, the input interface 61 (instruction operation actuator 65) is operable to individually receive an instruction to perform the first vibration control and an instruction to perform the second vibration control. For example, the instruction operation actuator 65 includes a first operation member that receives an instruction to perform the first vibration control and a second operation member that receives an instruction to perform the second vibration control. At this time, the first operation member and the second operation member may be arranged adjacent to each other or may be arranged at different locations. When the first operation member and the second operation member are arranged at different locations, for example, the first operation member is arranged inside (around the operator's seat 12) the protecting mechanism 13, and the second operation member is arranged outside (for example, at a fender) the protecting mechanism 13.

The instruction operation actuator 65 may receive operation of an instruction to perform the first vibration control and operation of an instruction to perform the second vibration control by the common input operation actuator 62. In such a case, the instruction operation actuator 65 selectively receives the operation of the instruction to perform the first vibration control and the operation of the instruction to perform the second vibration control by receiving different operations. For example, the instruction operation actuator 65 receives the instruction to perform the first vibration control by being operated with a single press and receives the instruction to perform the second vibration control by being operated with a long press.

Note that the instruction operation actuator 65 may receive operation of an instruction to terminate the first vibration control and operation of an instruction to terminate the second vibration control by a common operation member or by individual operation members.

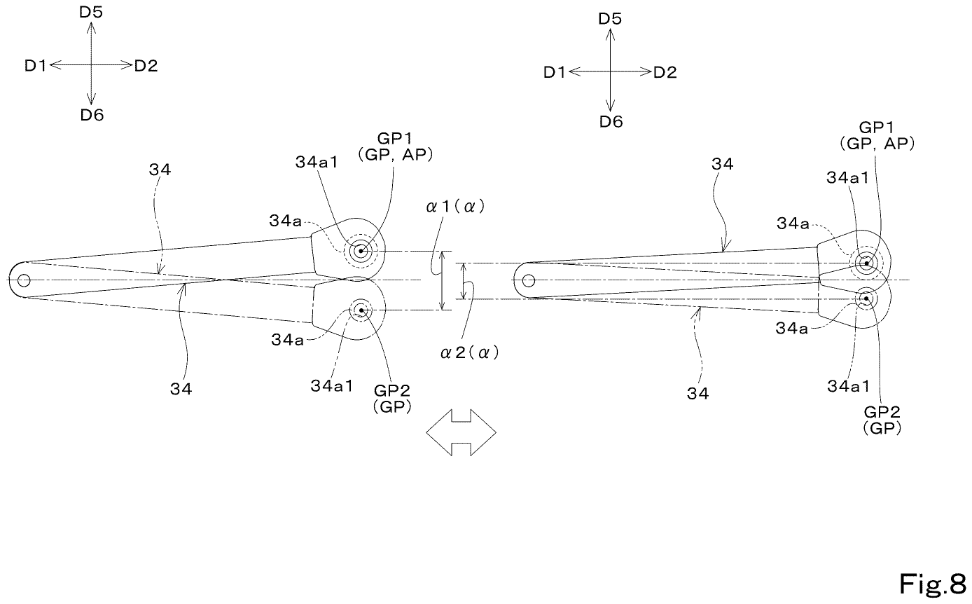

FIG. 8 illustrates a comparison of vibration of the linkage 34 between the first vibration control and the second vibration control. In FIG. 8, the left diagram illustrates vibration of the linkage 34 in the first vibration control, and the right diagram illustrates vibration of the linkage 34 in the second vibration control. As illustrated in FIG. 8, a first amplitude α1 of vibration of the linkage 34 in the first vibration control is larger than a second amplitude α2 of vibration of the linkage 34 in the second vibration control. That is, vibration of the linkage 34 is larger in the first vibration control than in the second vibration control. In other words, vibration of the linkage 34 is smaller in the second vibration control than in the first vibration control. Specifically, the first amplitude α1 is defined by, for example, a value of 40 mm to 60 mm or the like. In contrast, the second amplitude α2 is defined by, for example, a value of 20 mm to 40 mm or the like.

Note that the period of each vibration may be the same between the first vibration control and the second vibration control or may be longer in the first vibration control than in the second vibration control.

The controller 71 may cause the working device 45 to be driven in the vibration control. In the present example embodiment, the controller 71 causes the working device 45 to be driven in the first vibration control. Meanwhile, the controller 71 does not cause the working device 45 to be driven in the second vibration control. That is, when performing the first vibration control, the controller 71 causes the third motor 15c to be driven to drive the working device 45 linked to the linkage 34. Meanwhile, when performing the second vibration control, the controller 71 causes the third motor 15c to stop.

The controller 71 may control the rotational driving of the output shaft 41 in vibration control (the first vibration control in the present example embodiment). For example, the controller 71 may perform at least one of first switching control and second switching control in the vibration control. In the present example embodiment, an example in which the controller 71 is configured or programmed to perform the first switching control will be described.

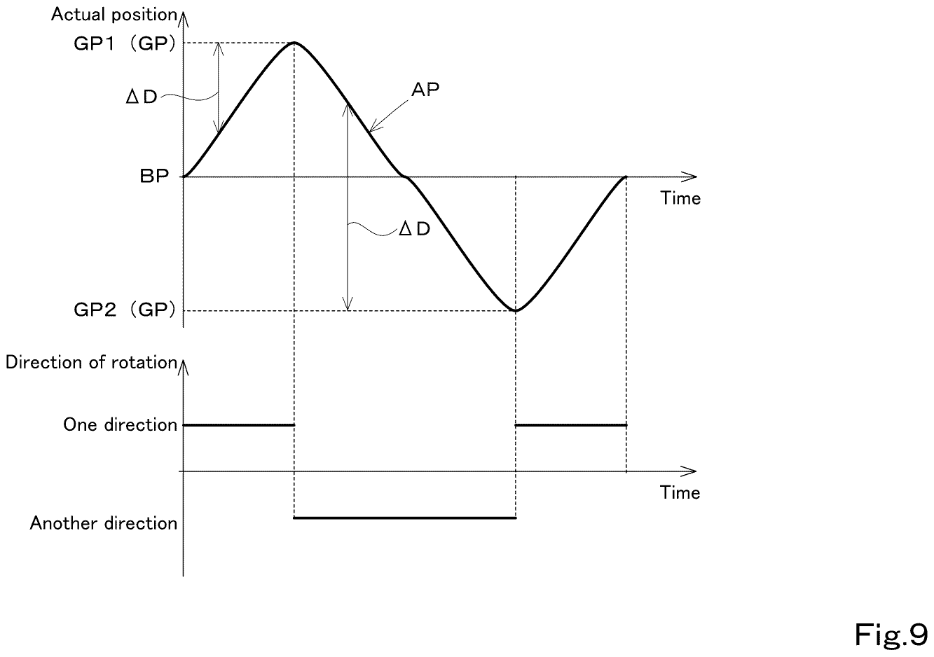

First, the first switching control will be described. FIG. 9 is a graph illustrating one example of a relationship between vibration control and driving of the working device 45 in the first switching control. In FIG. 9, a relationship between the actual position AP of the linkage 34 and the direction of rotation of the output shaft 41 in the first vibration control is illustrated. In particular, in FIG. 9, the upper graph illustrates change in the actual position AP relative to time, and the lower graph illustrates the direction of rotation of the output shaft 41 relative to time.

As illustrated in FIG. 9, the controller 71 switches, as the first switching control, the direction of rotation of the output shaft 41 in the vibration control (the first vibration control in the present example embodiment). In the vibration control, the controller 71 may perform the first switching control to switch the direction of rotation of the output shaft 41 a plurality of times during a period (single period) in which the linkage 34 is reciprocated once in the up-down direction and may switch the direction of rotation of the output shaft 41 once during a plurality of the periods. In the following description, an example in which the controller 71 performs the first switching control to switch the direction of rotation of the output shaft 41 a plurality of times during the aforementioned single period will be described.

As illustrated in FIG. 9, in the vibration control, the controller 71 performs the first switching control as the linkage 34 is moved up and down. Specifically, in the vibration control, the controller 71 performs the first switching control when the direction of movement of the linkage 34 is switched over. The controller 71 controls the drive actuator 36 to move the linkage 34 toward one side in the up-down direction and, when the linkage 34 reaches the maximum deviation (the uppermost point or the lowermost point) of the amplitude α, changes the direction of rotation of the output shaft 41 by the first switching control.

For example, during raising of the linkage 34, when the linkage 34 reaches the uppermost point and the difference ΔD with respect to the first target position GP1 becomes zero, the controller 71 controls the inverter 17 to switch the direction of rotation of the output shaft 41 from one direction (forward rotation, for example, clockwise rotation as viewed from the rear) to another direction (backward rotation, for example, counterclockwise rotation as viewed from the rear). During lowering of the linkage 34, when the linkage 34 reaches the lowermost point and the difference ΔD with respect to the second target position GP2 becomes zero, the controller 71 controls the inverter 17 to switch the direction of rotation of the output shaft 41 from the other direction to the one direction.

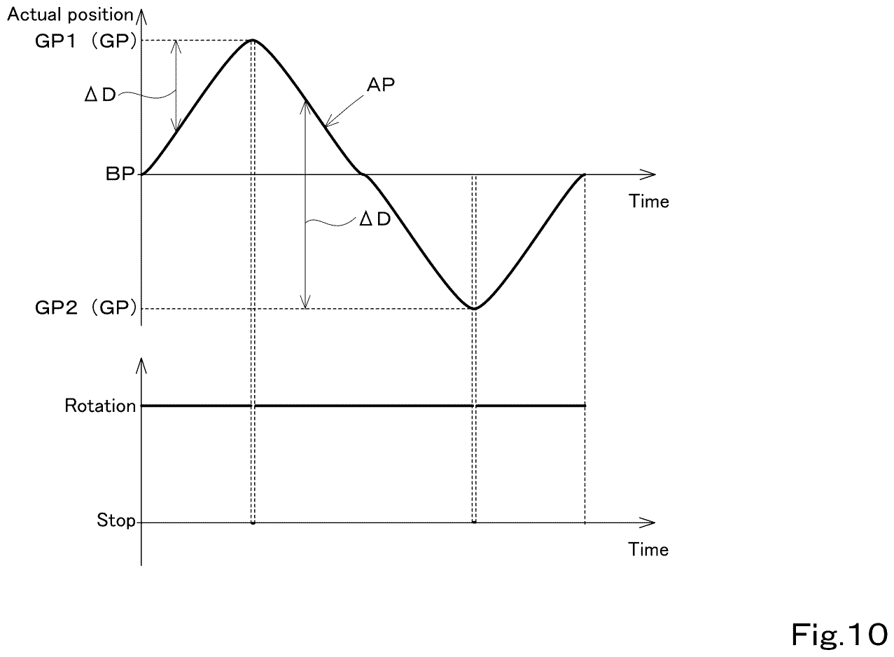

Next, the second switching control will be described. FIG. 10 is a graph illustrating one example of a relationship between the vibration control and driving of the working device 45 in the second switching control. In FIG. 10, a relationship between the actual position AP of the linkage 34 and the rotation and stop of the output shaft 41 in the first vibration control is illustrated. In particular, in FIG. 10, the upper graph illustrates change in the actual position AP relative to time, and the lower graph illustrates the rotation and stop of the output shaft 41 relative to time.

As illustrated in FIG. 10, in the vibration control, the controller 71 switches, as the second switching control, starting and stopping the rotational driving. In the second switching control, the controller 71 controls the inverter 17 to switch the rotation and stop of the third motor 15c. In the vibration control, the controller 71 may perform the second switching control to switch the rotation and stop of the output shaft 41 a plurality of times during a period (single period) in which the linkage 34 is reciprocated once in the up-down direction and may switch the rotation and stop of the output shaft 41 once during a plurality of the periods. In the following description, an example in which the controller 71 performs the second switching control to switch the rotation and stop of the output shaft 41 a plurality of times during the aforementioned single period will be described.

As illustrated in FIG. 10, in the vibration control, the controller 71 performs the second switching control as the linkage 34 is moved up and down. Specifically, in the vibration control, the controller 71 performs the second switching control when the direction of movement of the linkage 34 is switched over. The second switching control differs from the first switching control in that the direction of rotation of the output shaft 41 is not changed in the second switching control.

The controller 71 controls the drive actuator 36 to move the linkage 34 toward one side in the up-down direction and, when the linkage 34 reaches the maximum deviation (the uppermost point or the lowermost point) of the amplitude α, stops the rotation of the output shaft 41 by the second switching control. When controlling the drive actuator 36 to cause the linkage 34 such that the linkage 34 moves from the maximum deviation of the amplitude α to another side in the up-down direction, the controller 71 starts the rotation of the output shaft 41 by the second switching control. That is, by performing the second switching control when the direction of movement of the linkage 34 is switched over, the controller 71 stops the rotation of the output shaft 41 when the linkage 34 is located at the maximum deviation and rotates the output shaft 41 when the linkage 34 is located at a portion other than the maximum deviation.

For example, during raising of the linkage 34, when the linkage 34 reaches the uppermost point and the difference ΔD with respect to the first target position GP1 becomes zero, the controller 71 controls the inverter 17 to stop the rotation of the output shaft 41. When the linkage 34 moves downward from the uppermost point and the difference ΔD with respect to the second target position GP2 tends to decrease, the controller 71 controls the inverter 17 to start the rotation of the output shaft 41. Meanwhile, during lowering of the linkage 34, when the linkage 34 reaches the lowermost point and the difference ΔD with respect to the second target position GP2 becomes zero, the controller 71 controls the inverter 17 to stop the rotation of the output shaft 41. When the linkage 34 moves upward from the lowermost point and the difference ΔD with respect to the first target position GP1 tends to decrease, the controller 71 controls the inverter 17 to start the rotation of the output shaft 41.

Note that, although the switching control has been described in the above description with an example in which the working device 45 linked to the linkage 34 is supplied with power from the output shaft 41, it is sufficient for the controller 71, when the working device 45 is driven by an electric actuator, a hydraulic motor, or the like without being supplied with power from the outside, to control each of control targets (the inverter 17, the switch valve 42, and the like) to achieve the aforementioned switching control.

As described above, the controller 71 in the present example embodiment is configured or programmed to control the driven speed of the drive actuator 36 by controlling output of the hydraulic pump P. Therefore, the controller 71 may be configured or programmed to control (speed control) the driven speed of the drive actuator 36 in the vibration control. Specifically, for example, the controller 71 controls (first speed control) the driven speed (moving speed) of the drive actuator 36 to be faster while the vibration control is performed than while the vibration control is not performed. Therefore, the controller 71 controls, as the first speed control, the rotational speed of the hydraulic pump P while the vibration control is performed to be higher than the rotational speed of the hydraulic pump P while the vibration control is not performed. Consequently, the upward moving speed of the linkage 34 increases while the vibration control is performed compared with that while the vibration control is not performed.

Since the controller 71 in the present example embodiment controls the rotational speed of the hydraulic pump P to be a rated rotational speed while the vibration control is not performed, the controller 71 increases, as the first speed control, the rotational speed of the hydraulic pump P to be higher than the rated rotational speed in the vibration control. For example, the controller 71 controls the rotational speed of the first motor 15a to be higher by a predetermined value (additional rotational speed) than the rated rotational speed. The additional rotational speed is, for example, a previously defined fixed value (for example, 100 rpm) and is previously stored in the storing device 72. Therefore, the controller 71 acquires the additional rotational speed from the storing device 72 and controls the rotational speed of the first motor 15a to be a target rotational speed obtained by adding the additional rotational speed to the rated rotational speed.

Note that the additional rotational speed stored in the storing device 72 may be editable, as appropriate, based on information for which an input is received by the input interface 61 (the input operation actuator 62, the communicator 66, and/or the like).

Although the controller 71 that adds the additional rotational speed to the rated rotational speed has been described in the above example, a target rotational speed after addition may be stored in the storing device 72, and the controller 71 may acquire the target rotational speed to control the rotational speed of the first motor 15a to be higher by the additional rotational speed than the rated rotational speed. As another example, when the controller 71 is configured or programmed to change the target rotational speed of the first motor 15a based on information for which an input is received by the input interface 61, as in a case where the operation device 51 includes the rotation operation actuator 64, the controller 71 may control the rotational speed of the first motor 15a to be higher than the target rotational speed when performing the vibration control. For example, the controller 71 corrects the target rotational speed and controls the rotational speed of the first motor 15a to be a rotational speed that is higher by the additional rotational speed than the target rotational speed.

The controller 71 may not need to perform the first speed control of the hydraulic pump P in each of the first vibration control and the second vibration control. For example, the controller 71 may perform the first speed control when performing the first vibration control and not need to perform the first speed control when performing the second vibration control.

When the controller 71 is configured or programmed to perform the first vibration control and the second vibration control, the controller 71 may cause the driven speed of the drive actuator 36 to be different between the first vibration control and the second vibration control. For example, the controller 71 is configured or programmed to control (second speed control) the driven speed of the drive actuator 36 such that the driven speed when performing the first vibration control is faster than the driven speed when performing the second vibration control. Note that, although an example in which, to perform the second speed control, the driven speed (moving speed) of the drive actuator 36 while the vibration control is performed is controlled to be faster than the driven speed while the vibration control is not performed will be described in the following description, this does not imply any limitation. That is, the driven speed while the second vibration control is performed and the driven speed while the vibration control is not performed may be the same value.

Specifically, the controller 71 causes the rotational speed of the hydraulic pump P in the first vibration control to be higher than the rotational speed of the hydraulic pump P in the second vibration control. The controller 71 causes the rotational speed of the first motor 15a in the first vibration control to be higher than the rotational speed of the first motor 15a in the second vibration control. In other words, the controller 71 causes the rotational speed of the first motor 15a in the second vibration control to be lower than the rotational speed of the first motor 15a in the first vibration control. Consequently, the upward moving speed of the linkage 34 can be increased more while the first vibration control is performed than while the second vibration control is performed.

Since the controller 71 in the present example embodiment controls the rotational speed of the hydraulic pump P to be the rated rotational speed while the vibration control is not performed, the controller 71 controls, as the second speed control, the rotational speed of the hydraulic pump P in the first vibration control to be higher by a first additional rotational speed than the rated rotational speed. The first additional rotational speed is, for example, a previously defined fixed value (for example, 200 rpm) and is previously stored in the storing device 72.

Meanwhile, in the second vibration control, the controller 71 controls, as the second speed control, the rotational speed of the hydraulic pump P to be higher by a second additional rotational speed than the rated rotational speed. The second additional rotational speed is lower than the first additional rotational speed. The second additional rotational speed is, for example, a previously defined fixed value (for example, 100 rpm) and is previously stored in the storing device 72. Therefore, the controller 71 acquires, from the storing device 72, an additional rotational speed (the first additional rotational speed or the second additional rotational speed) in accordance with the vibration control that is to be performed, and the controller 71 controls the rotational speed of the first motor 15a to be a target rotational speed obtained by adding the additional rotational speed to the rated rotational speed.

Note that the second speed control described above is merely one example, and the variation described for the first speed control may be used, as appropriate.

The controller 71 may change the driven speed of the drive actuator 36 as the linkage 34 is moved up and down. For example, the controller 71 causes (third speed control) the driven speed in the vibration control to increase with increasing distance from the center (reference position BP) of the amplitude α of up-down movement of the linkage 34 to the maximum deviation of the amplitude α. In the present example embodiment, since the controller 71 changes output of the hydraulic pump P to control the driven speed, the controller 71 increases the moving speed of the linkage 34 when the linkage 34 is moved from the reference position BP toward the maximum deviation (first target position GP1) above by the third speed control.

Note that, although an example in which the controller 71 performs the third speed control in the first vibration control and does not perform the third speed control in the second vibration control will be described in the following description, this does not imply any limitation. That is, the controller 71 may perform the third speed control in both of the first vibration control and the second vibration control.

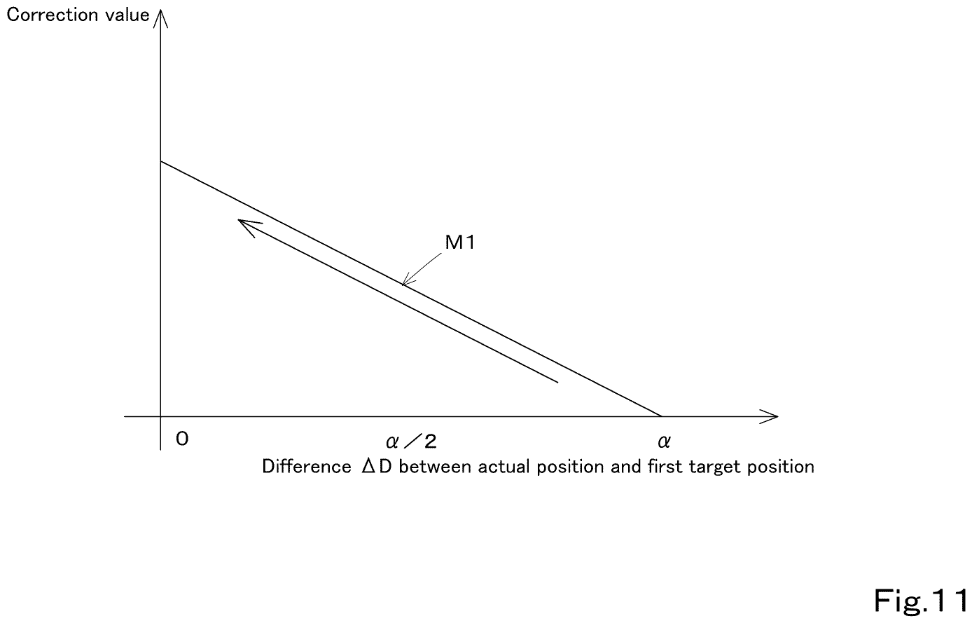

For example, in the first vibration control, the controller 71 corrects a target rotational speed, in which the additional rotational speed is added, with a correction value to perform the third speed control. The storing device 72 stores a first map M1 (graph) illustrating a relationship between the correction value and the difference ΔD between the actual position AP and the first target position GP1 (refer to FIG. 11). In the first map M1 illustrated in FIG. 11, the horizontal axis indicates the difference ΔD between the actual position AP and the first target position GP1, and the vertical axis indicates the correction value. In an example of the first map M1 illustrated in FIG. 11, the correction value changes so as to increase in proportion to the difference ΔD between the actual position AP and the first target position GP1 approaching zero. Therefore, in the first vibration control, the controller 71 acquires a correction value corresponding to the difference ΔD between the actual position AP and the first target position GP1 and corrects a target rotational speed with the correction value, thereby causing the moving speed of the linkage 34 to increase as the linkage 34 moves from the center of the amplitude α toward the maximum deviation above.

Note that the control map illustrated in FIG. 11 is one example and that the correction value may change so as to draw a substantially curved line such that the correction value gradually increases and then suddenly increases or change so as to draw a substantially curved line such that the correction value suddenly increases and then gradually increases as the difference ΔD between the actual position AP and the first target position GP1 approaches zero.

The speed control is not limited to the first to third speed controls described above. For example, the controller 71 may change the driven speed of the drive actuator 36 in accordance with a load that acts on the linkage 34 in the up-down direction. In such a case, the controller 71 changes the driven speed in the vibration control, similarly to the correction of the reference position BP in accordance with a load acting on the linkage 34, based on the amount of change per hour in the difference ΔD between the first target position GP1 and the actual position AP during a period in which the vibration control is performed or during a period in which the linkage 34 is moved upward first time through the vibration control. The controller 71 may increase output (the rotational speed of the first motor 15a) of the hydraulic pump P as the load increases and may increase output of the hydraulic pump P by a predetermined value if determining that the load is more than or equal to a predetermined load.

The controller 71 may be configured or programmed to permit the vibration control to be performed when a predetermined execution condition is satisfied, and to stop or not perform the vibration control when the condition is not satisfied. That is, even when the input interface 61 receives an input of an instruction to perform the vibration control, the controller 71 does not perform the vibration control based on the instruction if determining that an execution condition is not satisfied. If determining that an execution condition is not satisfied while the vibration control is performed, the controller 71 terminates or suspends the vibration control that is being performed. When the vibration control is suspended, the controller 71 restarts the suspended vibration control if determining that an execution condition is satisfied.

Note that it is sufficient for the controller 71 not to perform the vibration control if determining that an execution condition is not satisfied. That is, when the input interface 61 receives an input of an instruction to perform the vibration control while an execution condition is not satisfied, the controller 71 may perform the vibration control based on the instruction when the execution condition is satisfied. Hereinafter, the vibration control that is stopped or not performed by the controller 71 will be described with first to third execution conditions as examples. However, when a plurality of execution conditions are provided (for example, two conditions including first and second execution conditions), the controller 71 allows the vibration control to be performed when all of the plurality of execution conditions are satisfied. In other words, the controller 71 stops or does not perform the vibration control when at least one of a plurality of execution conditions is not satisfied.

First, the first execution condition will be described. The first execution condition is an execution condition based on a travel state of the travel vehicle body 11 caused to travel by the traveling device 21. The controller 71 acquires a travel state and determines whether the first execution condition is satisfied. Specifically, the controller 71 determines that the first execution condition is satisfied if determining that the traveling device 21 is not causing the travel vehicle body 11 to travel. The controller 71 determines that the first execution condition is not satisfied if determining that the traveling device 21 is causing the travel vehicle body 11 to travel. Therefore, the controller 71 stops or does not perform the vibration control if determining that the traveling device 21 is causing the travel vehicle body 11 to travel.

For example, the controller 71 acquires an operation signal output from the acceleration operation actuator 63 and, based on the operation signal, determines whether the traveling device 21 is causing the travel vehicle body 11 to travel. When the operation amount of the acceleration operation actuator 63 is zero, it is determined that the traveling device 21 is not causing the travel vehicle body 11 to travel and that the first execution condition is satisfied. Meanwhile, when the operation amount of the acceleration operation actuator 63 exceeds zero, the controller 71 determines that the traveling device 21 is causing the travel vehicle body 11 to travel and that the first execution condition is not satisfied.

The controller 71 may determine whether the traveling device 21 is causing the travel vehicle body 11 to travel, based on a vehicle speed calculated from a result of detection by the rotation detector 83. When the vehicle speed is zero, the controller 71 determines that the traveling device 21 is not causing the travel vehicle body 11 to travel and that the first execution condition is satisfied. Meanwhile, when the vehicle speed exceeds zero, the controller 71 determines that the traveling device 21 is causing the travel vehicle body 11 to travel and that the first execution condition is not satisfied.

Note that whether the first execution condition is satisfied is not limited to be determined based on an operation signal from the acceleration operation actuator 63 or the vehicle speed. For example, when the working vehicle 1 includes the position detector 87, the controller 71 may determine whether the first execution condition is satisfied based on a positioned position positioned by the position detector 87. In such a case, when a positioned position does not move (in a period in which the positioned position does not move), the controller 71 determines that the traveling device 21 is not causing the travel vehicle body 11 to travel and that the first execution condition is satisfied. When a positioned position is moving (in a period in which the positioned position is moving), the controller 71 determines that the traveling device 21 is causing the travel vehicle body 11 to travel and that the first execution condition is not satisfied.

When the working vehicle 1 includes the sensor 86, the controller 71 may determine whether the first execution condition is satisfied based on a result of sensing by the sensor 86. In such a case, for example, when an estimated position of the working vehicle 1 based on a result of sensing does not move (in a period in which the estimated position does not move), the controller 71 determines that the traveling device 21 is not causing the travel vehicle body 11 to travel and that the first execution condition is satisfied. When an estimated position is moving (in a period in which the estimated position is moving), the controller 71 determines that the traveling device 21 is causing the travel vehicle body 11 to travel and that the first execution condition is not satisfied.

Further, when the detector 81 includes a sensor that detects an operation state (a braked state and a released state) of the parking brake, the controller 71 may determine whether the first execution condition is satisfied based on a result of detection by the sensor. In such a case, when the parking brake is in the braked state, the controller 71 determines that the traveling device 21 is not causing the travel vehicle body 11 to travel and that the first execution condition is satisfied.

Next, the second execution condition will be described. The second execution condition is an execution condition based on the specific position VP. The controller 71 acquires the specific position VP (an estimated position or a positioned position in the present example embodiment) and determines whether the second execution condition is satisfied. Specifically, if determining that the specific position VP is not located in a work area E1 in which work is performed, the controller 71 determines that the second execution condition is satisfied. If determining that the specific position VP is located in the work area E1, the controller 71 determines that the second execution condition is not satisfied. Therefore, the controller 71 stops or does not perform the vibration control if determining that the specific position VP is located in the work area E1.

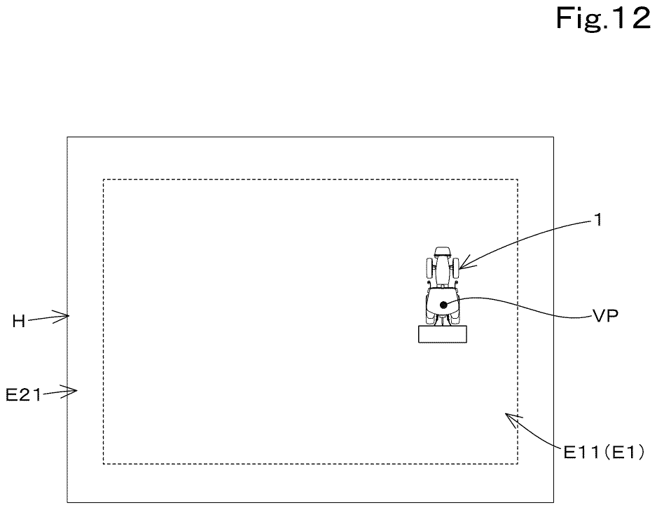

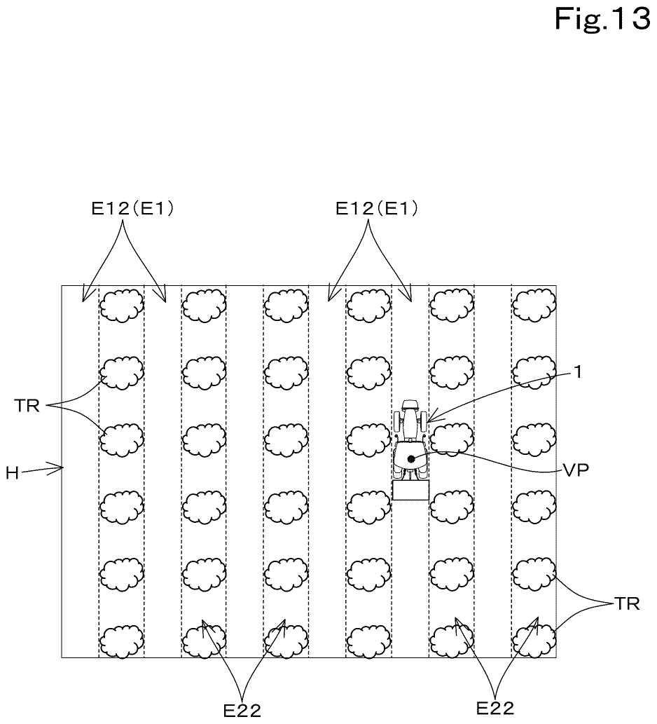

The work area E1 is a region in which a work subject on which the working device 45 performs work is located. Therefore, an example of the work area E1 is, in the agricultural field H, a region E11 (inner side region) on the inner side of a headland region E21 (refer to FIG. 12). The work area E1 is not limited to the inner side region E11. When the agricultural field H is an orchard, a plurality of fruit trees TR are planted with intervals in a predetermined direction in the orchard, and regions E12 (region between rows of the trees) between regions E22 (regions of rows of the trees) in which rows of the fruit trees TR are located are examples of the work area E1 (refer to FIG. 13).

For example, when the working vehicle 1 includes the position detector 87, the storing device 72 previously stores map information including the work area E1. The controller 71 determines whether the specific position VP is located in the work area E1 based on the map information in the storing device 72 and a positioned position positioned by the position detector 87.

When the working vehicle 1 includes the sensor 86, environmental map information stored in the storing device 72 is associated with the work area E1, and the controller 71 estimates whether the specific position VP is located in the work area E1 based on the environmental map information in the storing device 72 and a result (data of a detection point group) of sensing by the sensor 86.

Next, the third execution condition will be described. The third execution condition is an execution condition based on the remaining charge level of the battery 16. The controller 71 acquires the remaining charge level of the battery 16 and determines whether the third execution condition is satisfied. Specifically, when the remaining charge level is more than or equal to a predetermined level (more than or equal to a first remaining charge level), it is determined that the third execution condition is satisfied. When the remaining charge level is less than the predetermined level (less than the first remaining charge level), the controller 71 determines that the third execution condition is not satisfied. Therefore, if determining that the remaining charge level of the battery 16 is less than the predetermined level (less than the first remaining charge level), the controller 71 stops or does not perform the vibration control.

In the present example embodiment, the controller 71 refers to the remaining charge level of the battery 16 detected by the battery detector 82 and determines whether the remaining charge level is more than or equal to the first remaining charge level. The first remaining charge level is a predetermined value previously stored in the storing device 72, and the controller 71 refers to the storing device 72 to acquire the first remaining charge level. Note that the first remaining charge level stored in the storing device 72 may be editable, as appropriate, based on information for which an input is received by the input interface 61 (the input operation actuator 62, the communicator 66, and/or the like).

The controller 71 may correct the first remaining charge level, as appropriate, in accordance with a moving distance or a moving time to move from the position (specific position VP) of the working vehicle 1 to a charger (for example, a charging station) for charging the battery 16. In such a case, the storing device 72 stores the position of the charging station in the map information, and the controller 71 calculates the moving distance or the moving time based on a positioned position or an estimated position and the map information. The controller 71 corrects the first remaining charge level to be higher as the moving distance or the moving time increases and corrects the first remaining charge level to be lower as the moving distance or the moving time decreases. However, the moving distance and the moving time that are described above are examples, and a moving distance or a moving time of the working vehicle 1 to travel in remaining work from the position of the working vehicle 1 may be used.

Note that, although the first to third execution conditions have been described as the execution conditions in the above description, the execution conditions are not limited to the first to third execution conditions. For example, the execution conditions may include an execution condition (fourth execution condition) based on the orientation of the travel vehicle body 11, and the like. The controller 71 acquires a result of detection performed by the posture detector 88 and determines whether the fourth execution condition is satisfied based on the result of detection. Specifically, if determining that a difference of at least one of the roll angle and the pitch angle of the travel vehicle body 11 with respect to the horizontal direction is less than a predetermined value (less than an angular threshold value), the controller 71 determines that the fourth execution condition is satisfied. If determining that a difference of at least one of the roll angle and the pitch angle of the travel vehicle body 11 with respect to the horizontal direction is more than or equal to the predetermined value (more than or equal to the angular threshold value), the controller 71 determines that the fourth execution condition is not satisfied.

The controller 71 may stop or prevent driving of the drive actuator 36 in the vibration control when a predetermined stop/prevention (limitation) condition is satisfied. For example, the controller 71 acquires a remaining charge level of the battery 16 and, when a stop/prevention condition based on the remaining charge level is satisfied, stops or prevents driving of the drive actuator 36 in the vibration control. Specifically, when the remaining charge level is less than a predetermined level (less than a second remaining charge level), the controller 71 stops or prevents driving of the drive actuator 36 in the vibration control. For example, when a stop/prevention condition is satisfied, the controller 71 does not perform speed control of the rotational speed of the hydraulic pump P and maintains the rotational speed at the rated rotational speed in the vibration control. When a stop/prevention condition is satisfied, the controller 71 may decrease the rotational speed to be less than the rated rotational speed (for example, to a predetermined idling rotational speed less than the rotational speed and greater than zero) in the vibration control.

Similarly to the determination of the third execution condition, the controller 71 refers to the remaining charge level of the battery 16 detected by the battery detector 82 and determines whether the remaining charge level is more than or equal to the second remaining charge level. The second remaining charge level is a predetermined value previously stored in the storing device 72, and the controller 71 refers to the storing device 72 to acquire the second remaining charge level. When the controller 71 is configured or programmed to stop or prevent the vibration control based on the third execution condition, the second remaining charge level is defined by a value higher than the first remaining charge level.

Note that the second remaining charge level stored in the storing device 72 may be editable, as appropriate, based on information for which an input is received by the input interface 61 (the input operation actuator 62, the communicator 66, and/or the like). The controller 71 may correct the second remaining charge level, similarly to the first remaining charge level, in accordance with a moving distance and a moving time, as appropriate. As a method of correcting the second remaining charge level, the same method as the method of correcting the first remaining charge level is usable, and detailed description thereof is thus omitted.

Although the controller 71 that performs vibration control when the input interface 61 receives an instruction to perform the vibration control has been described in the example embodiment described above, the controller 71 may perform vibration control automatically when the lower link 34 is manually operated by an operator. For example, if determining that the lower link 34 is pushed down or pushed up by an operator, the controller 71 performs vibration control (second vibration control). Specifically, if determining that the linkage 34 is moved (swung) in the up-down direction, the controller 71 performs the second vibration control regardless of driving of the drive actuator 36.

For example, based on whether the manual operator 54 is operated, the controller 71 determines whether the linkage 34 is swung by driving of the drive actuator 36. In such a case, the manual operator 54 is provided with an operation detection sensor 54a (for example, a potentiometer) that detects swinging operation, and, based on a result of detection by the potentiometer, the controller 71 determines whether the manual operator 54 is operated.

The controller 71 detects swinging of the linkage 34 in the up-down direction based on a result of detection by the raising/lowering detector 85. Note that, when the drive actuator 36 is a hydraulic cylinder, a pressure sensor is provided in a fluid passage that connects the drive actuator 36 and the control valve 37 to each other, and, based on a result of detection by the pressure sensor, the controller 71 detects swinging of the linkage 34 in the up-down direction. When the working vehicle 1 includes the sensor 86, the controller 71 may estimate whether the lower link 34 is pushed down or pushed up by an operator based on a result of sensing by the sensor 86.

Note that, although the controller 71 that performs the second vibration control when the lower link 34 is pushed down or pushed up by an operator has been described in the above description, the controller 71 may perform the first vibration control instead of the second vibration control.

Although the controller 71 controls the drive actuator 36 by controlling the drive unit 55 such that the drive unit 55 operates the manual operator 54 to swing in the example embodiment described above, it is sufficient that the manual operator 54 receives operation to move the linkage 34, that is, operation of the drive actuator 36 and that the controller 71 is configured or programmed to control the drive actuator 36. For example, the controller 71 may control (manual control) the drive actuator 36 in accordance with operation of the manual operator 54, separately from the vibration control. Consequently, the drive actuator 36 is operable to be controlled by a manual operation of the manual operator 54. Specifically, the control valve 37 is an electromagnetic proportional valve, and the controller 71 performs the manual control by outputting control electric current to the control valve 37 in accordance with operation of the manual operator 54 to control the drive actuator 36.

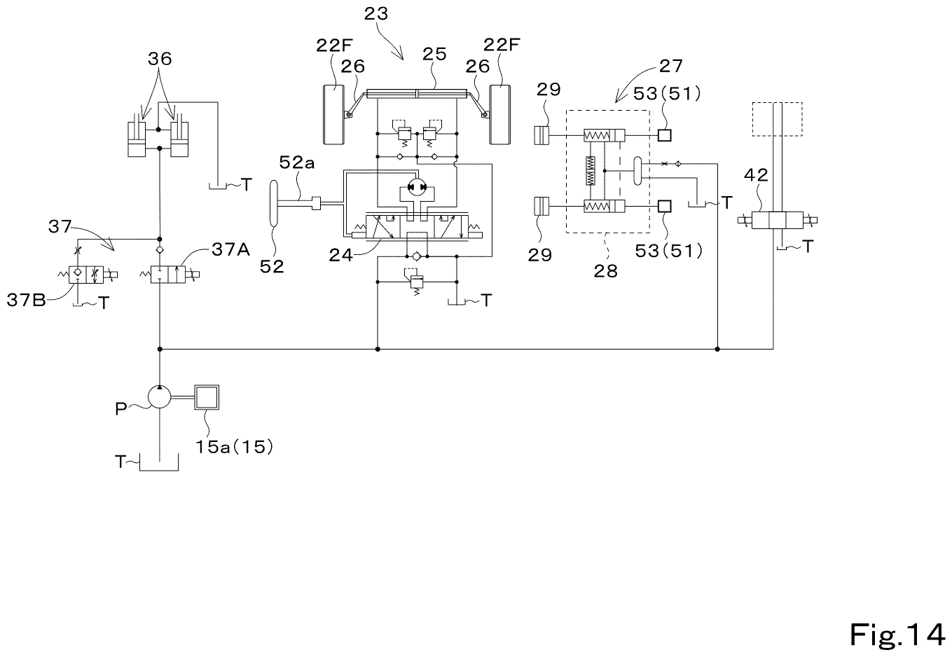

FIG. 14 illustrates one example of a hydraulic system of the working vehicle 1 in a variation. As in the example illustrated in FIG. 14, the control valve 37 includes a first control valve 37A (control valve for raising) that controls extension of the lift cylinder 36 (drive actuator) and a second control valve 37B (control valve for lowering) that controls retraction of the lift cylinder 36.

The first control valve 37A is provided in a fluid passage connecting the hydraulic pump P and the bottom fluid chamber to each other and can supply the hydraulic fluid, which is delivered by the hydraulic pump P, to the bottom fluid chamber by changing the opening of the first control valve 37A. The second control valve 37B is provided in a fluid passage connecting the bottom fluid chamber and the hydraulic-fluid tank T to each other and can discharge the hydraulic fluid in the bottom fluid chamber to the hydraulic-fluid tank T by changing the opening of the second control valve 37B. Note that, although the control valve 37 that includes the first control valve 37A and the second control valve 37B will be mainly described in the following example, a three-position electromagnetic switching valve switchable among a neutral position, a first position, and a second position may be used as the control valve 37.

In the variation, the manual operator 54 is provided with the operation detection sensor 54a (for example, a potentiometer) that detects swinging operation. Based on an operation signal output from the potentiometer, the controller 71 can define the target position GP of the linkage 34 (lower link) in the up-down direction. When the operation amount of the manual operator 54 in the first direction increases, the controller 71 defines the target position GP to be high in accordance with the operation amount. Meanwhile, when the operation amount of the manual operator 54 in the second direction decreases, the controller 71 defines the target position GP to be low in accordance with the operation amount.

The controller 71 controls the control valve 37 such that the difference ΔD between the target position GP, which is defined in accordance with the operation amount of the manual operator 54, and the actual position AP becomes zero. The controller 71 outputs control electric current to the control valve 37 in accordance with an operation signal output from the manual operator 54, thereby controlling the control valve 37.

Note that, although the controller 71 that controls output of the hydraulic pump P to control the driven speed of the drive actuator 36 has been described in the example embodiments described above, when the control valve 37 includes an electromagnetic proportional valve as in the variation illustrated in FIG. 14, the controller 71 can control the driven speed by controlling the opening of the control valve 37 to change the flow rate of the hydraulic fluid that is to be supplied to the drive actuator 36 and the flow rate of the hydraulic fluid that is to be discharged from the drive actuator 36. Therefore, in the variation illustrated in FIG. 14, the controller 71 can perform speed control by changing control electric current that is to be output to the control valve 37. Consequently, the upward moving speed of the linkage 34 increases while the vibration control is performed compared with that while the vibration control is not performed.

When the controller 71 performs the second speed control in the variation, the controller 71 is described such that the controller 71 reduces control electric current that is output to the control valve 37 in the second vibration control to be smaller than control electric current that is output to the control valve 37 in the first vibration control. The control electric current (first control electric current) in the first vibration control is higher than the control electric current (second control electric current) in the second vibration control. The first control electric current and the second control electric current are previously stored in the storing device 72. The storing device 72 may store one of the first control electric current and the second control electric current, and the controller 71 may correct the one to acquire the other control electric current and reduce the second control electric current to be smaller than the first control electric current.

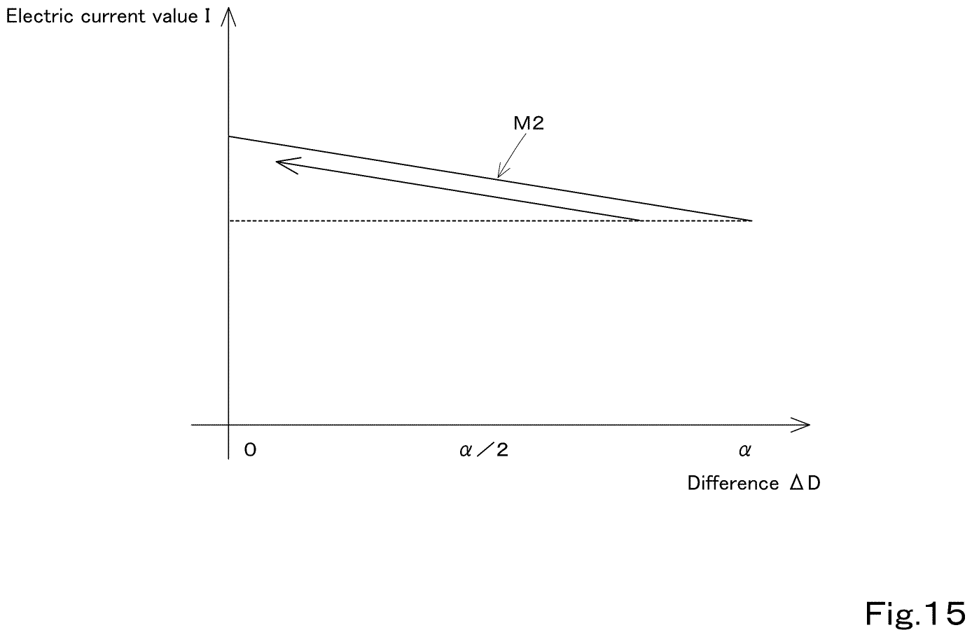

When the controller 71 performs the third speed control in the variation, the controller 71 is described such that the controller 71 increases the driven speed in the vibration control by increasing the control electric current with increasing distance from the center of the amplitude α in up-down movement of the linkage 34 to the maximum deviation of the amplitude α. For example, the storing device 72 stores a second map (graph) illustrating a relationship between the first control electric current and the difference ΔD between the actual position AP and the target position GP (refer to FIG. 15). Note that, in FIG. 15, the first control electric current is indicated by a solid line and the second control electric current is indicated by a broken line for comparison between the first control electric current and the second control electric current.

In the control map illustrated in FIG. 15, the horizontal axis indicates the difference ΔD, and the vertical axis indicates an electric current value I of the first control electric current. In the example of the control map illustrated in FIG. 15, the electric current value I changes so as to increase in proportion to the difference ΔD decreasing and approaching zero. Note that the control map illustrated in FIG. 15 is one example, and the electric current value I may change so as to draw a substantially curved line such that the electric current value I gradually increases and then suddenly increases or may change so as to draw a substantially curved line such that the electric current value I suddenly increases and then gradually increases as the difference ΔD approaches zero.

Note that, although the control valve 37 that is an electromagnetic proportional valve has been described in the variation described above, when the drive actuator 36 is an electric actuator, the controller 71 may control the driven speed of the drive actuator 36 by controlling the inverter 17 to control the electricity that is to be supplied to the drive actuator 36 from the battery 16 via the inverter 17. In such a case, it is sufficient to replace the electric current value of the control electric current in the above-described variation with the electric current value of the electricity to be supplied to the drive actuator 36, and detailed description thereof is thus omitted.

When, as in the above-described variation and the like, the drive actuator 36 is manually operated by the controller 71 controlling (manual control) the drive actuator 36 in accordance with operation of the manual operator 54, the controller 71 may allow manual operation when a predetermined operation condition is satisfied and stop or prevent manual operation when the operation condition is not satisfied. That is, even when the manual operator 54 is manually operated, the controller 71 does not control (manual control) the drive actuator 36 by the manual operation if determining that an operation condition is not satisfied. If determining that an operation condition is not satisfied while manual control is performed, the controller 71 terminates or suspends the manual control that is being performed. When suspended the manual control, the controller 71 restarts the suspended manual control if determining that an operation condition is satisfied.

Note that it is sufficient for the controller 71 not to perform the manual control if determining that an operation condition is not satisfied. That is, when the manual operator 54 receives manual operation while an operation condition is not satisfied, the controller 71 may perform manual control when the operation condition is satisfied. Hereinafter, stop/prevention of manual operation (manual control) by the controller 71 will be described with the first and second operation conditions as examples. However, when a plurality of operation conditions are provided (for example, two conditions including first and second operation conditions), the controller 71 allows manual operation when all of the plurality of operation conditions are satisfied. In other words, the controller 71 stops or prevents manual operation when at least one of the plurality of operation conditions is not satisfied.

First, the first operation condition will be described. The first operation condition is an operation condition based on the specific position VP. The controller 71 acquires the specific position VP (an estimated position or a positioned position in the present example embodiment) and determines whether the first operation condition is satisfied. When the first operation condition is satisfied, the controller 71 allows upward movement of the linkage 34 by a manual operation. Meanwhile, when the first operation condition is not satisfied, the controller 71 stops or prevents upward movement of the linkage 34 by a manual operation.

Specifically, if determining that the specific position VP is not located in the work area E1 in which work is performed, the controller 71 determines that the first operation condition is satisfied. If determining that the specific position VP is located in the work area E1, the controller 71 determines that the first operation condition is not satisfied. That is, in the present example embodiment, the first operation condition is the same as the second execution condition. Accordingly, if determining that the specific position VP is located in the work area E1, the controller 71 stops or prevents upward movement of the linkage 34 by a manual operation.

When the actual position AP is lower than the target position GP defined in accordance with the operation amount of the manual operator 54, the controller 71 suspends or terminates control (manual control) of the drive actuator 36 based on the difference ΔD between the target position GP and the actual position AP if determining that the first operation condition is not satisfied. Meanwhile, when the actual position AP is lower than the target position GP defined in accordance with the operation amount of the manual operator 54, the controller 71 performs control (manual control) of the drive actuator 36 based on the difference ΔD between the target position GP and the actual position AP if determining the first operation condition is satisfied.

Next, the second operation condition will be described. The second operation condition is a stop/prevention condition based on a travel state of the travel vehicle body 11 caused to travel by the traveling device 21. The controller 71 acquires a travel state and determines whether the second operation condition is satisfied. Specifically, if determining that the travel vehicle body 11 is not turning, the controller 71 determines that the second operation condition is satisfied. If determining that the travel vehicle body 11 is turning, the controller 71 determines that the second operation condition is not satisfied. When the second operation condition is satisfied, the controller 71 allows downward movement of the linkage 34 by a manual operation. Meanwhile, when the second operation condition is not satisfied, the controller 71 stops or prevents downward movement of the linkage 34 by a manual operation.

Specifically, the controller 71 determines whether turning is performed based on a steering angle based on a result of detection by the steering detector 84. In such a case, when the steering angle is more than or equal to a predetermined determination value, the controller 71 determines that the steering angle is relatively large and that the travel vehicle body 11 is turning. Meanwhile, when the steering angle is less than the determination value, the controller 71 determines that the steering angle is relatively small and that the travel vehicle body 11 is traveling straight.

Note that the controller 71 may determine whether the travel vehicle body 11 is turning based on, instead of the steering angle, the position of the working vehicle 1 in the agricultural field H. For example, when the working vehicle 1 includes the position detector 87, the storing device 72 stores map information including the headland region E21. Based on the map information in the storing device 72 and a positioned position positioned by the position detector 87, the controller 71 determines whether the specific position VP is located in the headland region E21. When the working vehicle 1 includes the sensor 86, the environmental map information stored in the storing device 72 is associated with the headland region E21, and the controller 71 estimates whether the specific position VP is located in the headland region E21 based on the environmental map information in the storing device 72 and a result (data of a detection point group) of sensing by the sensor 86.

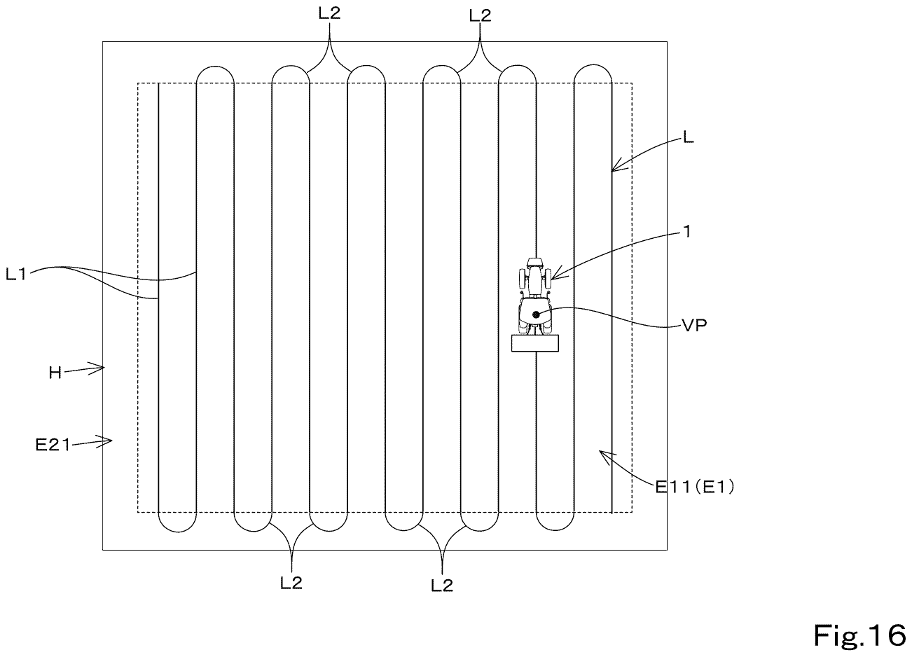

The controller 71 may determine whether the travel vehicle body 11 is turning based on the position of the working vehicle 1 on a planned travel line L, which is a path along which the working vehicle 1 travels. FIG. 16 illustrates one example of the planned travel line L. As illustrated in FIG. 16, the planned travel line L is a traveling path including a straight travel section L1 in which the travel vehicle body 11 travels straight and a turning section L2 in which the travel vehicle body 11 turns. The planned travel line L is previously defined and stored in the storing device 72 by an operator through operation of a portable terminal or the like.

When the working vehicle 1 includes the position detector 87, the controller 71 determines whether the specific position VP is located in the turning section L2 based on the planned travel line L in the storing device 72 and a positioned position positioned by the position detector 87. When the working vehicle 1 includes the sensor 86, the controller 71 determines whether the specific position VP is located in the turning section L2 based on the planned travel line L in the storing device 72 and an estimated position estimated from a result of sensing.

Accordingly, when the target position GP defined in accordance with the operation amount of the manual operator 54 is lower than the actual position AP, the controller 71 suspends or terminates control (manual control) of the drive actuator 36 based on the difference ΔD between the target position GP and the actual position AP if determining that the second operation condition is not satisfied. Meanwhile, when the target position GP defined in accordance with the operation amount of the manual operator 54 is lower than the actual position AP, the controller 71 performs control (manual control) of the drive actuator 36 based on the difference ΔD between the target position GP and the actual position AP if determining that the second operation condition is satisfied.

Although the working device 45 that is linked to the linkage 34 has been described in the above description, the linkage 34 may allow devices and instruments other than the working device 45 to be linked thereto. For example, the linkage 34 may allow, instead of or in addition to the working device 45, an auxiliary battery (a sub-battery, a range extender) to be linked thereto. The auxiliary battery is operable to supply electricity for driving the working vehicle 1. The auxiliary battery is operable to store electricity and is, for example, a secondary battery, such as a lithium ion battery, a lead storage battery, and the like. Note that it is sufficient for the auxiliary battery to be operable to supply electricity for driving the working vehicle 1, and the auxiliary battery may store electricity generated by a fuel battery. In such a case, the auxiliary battery includes a tank for storing a gas (for example, a hydrogen gas, a methane gas, or the like) and a fuel battery (fuel battery stuck) that is caused to generate electricity by the gas supplied from the tank.

Example embodiments of the present invention provide working vehicles 1 described in the following items.

(Item 1) A working vehicle 1 including a travel vehicle body 11, a traveling device 21 to support the travel vehicle body 11 such that the travel vehicle body 11 is allowed to travel, a linkage 34 on the travel vehicle body 11 to link a working device 45 thereto, a drive actuator 36 to move the linkage 34 in an up-down direction to raise and lower the working device 45 linked to the linkage 34, and a controller 71 configured or programmed to perform a vibration control to control the drive actuator 36 to vibrate the linkage 34.

With the working vehicle 1 according to item 1, the controller 71 is configured or programmed to cause the linkage 34 to vibrate by performing the vibration control without depending on operation by an operator. Additionally, since the controller 71 uses the drive actuator 36 that moves the linkage 34 in the up-down direction in the vibration control, the drive actuator 36 is able to function as both a driving source for up-down movement of the linkage 34 and a driving source for the aforementioned vibration.

(Item 2) The working vehicle 1 according to item 1, wherein the controller 71 is configured or programmed to selectively perform a first vibration control or a second vibration control as the vibration control, and a first amplitude α1 of vibration of the linkage 34 in the first vibration control is greater than a second amplitude α2 of vibration of the linkage 34 in the second vibration control.

With the working vehicle 1 according to item 2, the controller 71 is configured or programmed to change, by selecting the first vibration control or the second vibration control, the amplitude α in accordance with the purpose of vibrating the linkage 34 and/or the working device 45 linked to the linkage 34. Therefore, the working vehicle 1 makes it possible to improve versatility of the vibration control.

(Item 3) The working vehicle 1 according to item 2, wherein the controller 71 is configured or programmed to control driving of the working device 45 linked to the linkage 34 such that the working device 45 is driven in the first vibration control and the working device 45 is not driven in the second vibration control.

With the working vehicle 1 according to item 3, since the working device 45 is driven in the first vibration control, when the working device 45 is linked to the linkage 34, the controller 71 is able to cause adhering substances, such as soil, snow, water droplets, and/or the like, adhering to the working device 45 to be removed by vibration of the linkage 34 and driving of the working device 45 by performing the first vibration control. Additionally, since the working device 45 is not driven in the second vibration control in which the amplitude α of the linkage 34 is smaller than that in the first vibration control, it is possible to prevent or reduce unintended vibration of the working device 45 caused by driving of the working device 45.

(Item 4) The working vehicle 1 according to item 2 or 3, wherein the controller 71 is configured or programmed to control a driven speed of the drive actuator 36 such that the driven speed is higher in the first vibration control than in the second vibration control.

With the working vehicle 1 in item 4, since the driven speed is faster in the first vibration control than in the second vibration control, the controller 71 is able to cause adhering substances adhering to the working device 45 linked to the linkage 34 to be more appropriately removed by performing the first vibration control. Additionally, since the driven speed is slower in the second vibration control than in the first vibration control, it is possible to accurately perform alignment of the linkage 34 with respect to the working device 45 and alignment of the working device 45 linked to the linkage 34 with respect to another device or the like.

(Item 5) The working vehicle 1 according to item 1, further including an output shaft 41 to transmit a rotational driving force to the working device 45 linked to the linkage 34, wherein the controller 71 is configured or programmed to control rotational driving of the output shaft 41, and, in the vibration control, repeatedly perform at least one of (i) a first switching control to switch a direction of rotation of the output shaft 41 or (ii) a second switching control to switch between starting and stopping the rotational driving.

With the working vehicle 1 according to item 5, when the first switching control is performed in the vibration control, it is possible to change the driving direction of the working device 45 while vibrating the working device 45 linked to the linkage 34. Additionally, when the second switching control is performed in the vibration control, it is possible to change driving and stopping of the working device 45 while vibrating the working device 45 linked to the linkage 34. Therefore, the controller 71 is able to cause the working device 45 to operate in a complex manner to more appropriately remove adhering substances adhering to the working device 45 by performing the first switching control or the second switching control in the vibration control.

(Item 6) The working vehicle 1 according to item 5, wherein the controller 71 is configured or programmed to, in the vibration control, perform the first switching control or the second switching control as the linkage 34 is moved up and down.

With the working vehicle 1 according to item 6, the controller 71 is able to cause the working device 45 linked to the linkage 34 to operate in a more complex manner in the vibration control. Therefore, the working device 45 is able to remove adhering substances adhering to the working device 45 even more appropriately by operating in a more complex manner.

(Item 7) The working vehicle 1 according to item 6, wherein the controller 71 is configured or programmed to, in the vibration control, perform the first switching control or the second switching control when a direction of movement of the linkage 34 is switched over.

With the working vehicle 1 according to item 7, the controller 71 is configured programmed to cause the working device 45 linked to the linkage 34 to operate in a more complex manner in vibration control. Therefore, the working device 45 is able to remove adhering substances adhering to the working device 45 even more appropriately by operating in a more complex manner.

(Item 8) The working vehicle 1 according to item 1 or according to any one of items 5 to 7, wherein the controller 71 is configured or programmed to control a driven speed of the drive actuator 36 such that the driven speed in the vibration control increases with increasing distance from a center of an amplitude α of up-down movement of the linkage 34 to a maximum deviation of the amplitude α.

With the working vehicle 1 according to item 8, the driven speed increases as the working device 45 linked to the linkage 34 moves toward the maximum deviation of the amplitude α in vibration control, that is, immediately before the direction of movement of the working device 45 (linkage 34) is switched over and the movement is temporarily stopped. Therefore, it is possible, by increasing an inertia force that acts on the working device 45, to even more appropriately remove adhering substances adhering to the working device 45.

(Item 9) The working vehicle 1 according to item 1, wherein the controller 71 is configured or programmed to, in the vibration control, vibrate the linkage 34 such that a position of the linkage 34 in the up-down direction at a time when the vibration control is started is a center of an amplitude α of up-down movement of the linkage 34.

With the working vehicle 1 according to item 9, since the linkage 34 can be vibrated based on the time when the vibration control is started, it is possible to accurately perform alignment of the linkage 34 with respect to the working device 45 and alignment of the working device 45 linked to the linkage 34 with respect to another device or the like.

(Item 10) The working vehicle 1 according to any one of items 1 to 9, further including a manual operator 54 to receive an operation to cause the drive actuator 36 to move the linkage 34 in the up-down direction, wherein the drive actuator 36 is operable to be controlled by a manual operation of the manual operator 54.

With the working vehicle 1 according to item 10, it is possible for an operator to freely move the linkage 34 or the working device 45 linked to the linkage 34 by operating the manual operator 54 and causing the controller 71 to control the drive actuator 36 in accordance with operation of the manual operator 54, and it is possible for the drive actuator 36 to vibrate the working device 45 linked to the linkage 34 and vibrate the linkage 34 with respect to the working device 45 by vibration control.

(Item 11) The working vehicle 1 according to item 10, further including an input interface 61 to receive an instruction to perform the vibration control, and the controller 71 is configured or programmed to, upon receipt of the instruction by the input interface 61, perform the vibration control instead of the control by the manual operation.

With the working vehicle 1 according to item 11, the controller 71 is configured or programmed to perform the vibration control separately from the manual operation in accordance with an instruction from the input interface 61. Therefore, the controller 71 is able to appropriately perform the vibration control.

(Item 12) The working vehicle 1 according to any one of items 1 to 11, wherein the controller 71 is configured or programmed to acquire a travel state of the travel vehicle body 11 that is configured to be caused to travel by the traveling device 21, and stop or not perform the vibration control if determining that the traveling device 21 is causing the travel vehicle body 11 to travel based on the travel state.

With the working vehicle 1 according to item 12, it is possible to eliminate or reduce the likelihood that vibration control is unintentionally performed when the working vehicle 1 is caused to travel by the traveling device 21. For example, it is possible to eliminate or reduce the likelihood that vibration control is performed while the working vehicle 1 is performing work by using the working device 45 linked to the linkage 34 and that, consequently, the vibration control impedes the work performed with the working device 45.

(Item 13) The working vehicle 1 according to item 10 or 11, wherein the controller 71 is configured or programmed to acquire at least one of a specific position VP on the travel vehicle body 11 or a specific position VP on the working device 45 linked to the linkage 34, and stop or prevent upward movement of the linkage 34 by the manual operation or stop or not perform the vibration control if, based on the at least one of the specific position VP on the travel vehicle body or the specific position VP on the working device, determining that at least one of the specific position VP on the travel vehicle body or the specific position VP on the working device is located in a work area E1 in which work is performed.

With the working vehicle 1 according to item 13, it is possible to eliminate or reduce the likelihood that manual operation or vibration control is unintentionally performed when the specific position VP is located in the work area E1. Therefore, it is possible to eliminate or reduce the likelihood that manual operation or vibration control is performed while the working vehicle 1 is performing work by using the working device 45 linked to the linkage 34 and that, consequently, the manual operation or the vibration control impedes the work performed with the working device 45.

(Item 14) The working vehicle 1 according to item 10 or 11, wherein the controller 71 is configured or programmed to acquire a travel state of the travel vehicle body 11 that is configured to be caused to travel by the traveling device 21, and stop or prevent downward movement of the linkage 34 caused by the manual operation if determining that the travel vehicle body 11 is turning based on the travel state.

With the working vehicle 1 according to item 14, it is possible to eliminate or reduce the likelihood that the working device 45 linked to the linkage 34 is moved downward by a manual operation while the travel vehicle body 11 is turning. Therefore, it is possible to eliminate or reduce the likelihood that the working device 45 moves downward to come into contact with the ground and, consequently, impedes turning of the travel vehicle body 11.

(Item 15) The working vehicle 1 according to any one of items 1 to 14, wherein the drive actuator 36 and the traveling device 21 are configured to be driven directly or indirectly by electricity discharged from a battery 16, and the controller 71 is configured or programmed to stop or not perform driving of the drive actuator 36 in the vibration control when a remaining charge level of the battery 16 is less than a predetermined level.

With the working vehicle 1 according to item 15, the drive actuator 36 makes it possible to prevent or reduce consumption of the remaining charge level by being driven in vibration control when the remaining charge level of the battery 16 is relatively low. That is, it is possible to give priority to traveling performed by the traveling device 21 over vibration of the linkage 34 or the working device 45 linked to the linkage 34 caused by vibration control.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working vehicle comprising:
a travel vehicle body;
a traveling device to support the travel vehicle body such that the travel vehicle body is allowed to travel;
a linkage on the travel vehicle body to link a working device thereto;
a drive actuator to move the linkage in an up-down direction to raise and lower the working device linked to the linkage; and
a controller configured or programmed to perform a vibration control to control the drive actuator to vibrate the linkage.

2. The working vehicle according to claim 1, wherein
the controller is configured or programmed to selectively perform a first vibration control or a second vibration control as the vibration control; and
a first amplitude of vibration of the linkage in the first vibration control is greater than a second amplitude of vibration of the linkage in the second vibration control.

3. The working vehicle according to claim 2, wherein the controller is configured or programmed to control driving of the working device linked to the linkage such that the working device is driven in the first vibration control and the working device is not driven in the second vibration control.

4. The working vehicle according to claim 2, wherein the controller is configured or programmed to control a driven speed of the drive actuator such that the driven speed is higher in the first vibration control than in the second vibration control.

5. The working vehicle according to claim 1, further comprising an output shaft to transmit a rotational driving force to the working device linked to the linkage; wherein
the controller is configured or programmed to control rotational driving of the output shaft, and, in the vibration control, repeatedly perform at least one of (i) a first switching control to switch a direction of rotation of the output shaft or (ii) a second switching control to switch between starting and stopping the rotational driving.

6. The working vehicle according to claim 5, wherein the controller is configured or programmed to, in the vibration control, perform the first switching control or the second switching control as the linkage is moved up and down.

7. The working vehicle according to claim 6, wherein the controller is configured or programmed to, in the vibration control, perform the first switching control or the second switching control when a direction of movement of the linkage is switched over.

8. The working vehicle according to claim 1, wherein the controller is configured or programmed to control a driven speed of the drive actuator such that the driven speed in the vibration control increases with increasing distance from a center of an amplitude of up-down movement of the linkage to a maximum deviation of the amplitude.

9. The working vehicle according to claim 1, wherein the controller is configured or programmed to, in the vibration control, vibrate the linkage such that a position of the linkage in the up-down direction at a time when the vibration control is started is a center of an amplitude of up-down movement of the linkage.

10. The working vehicle according to claim 1, further comprising a manual operator to receive an operation to cause the drive actuator to move the linkage in the up-down direction; wherein
the drive actuator is operable to be controlled by a manual operation of the manual operator.

11. The working vehicle according to claim 10, further comprising an input interface to receive an instruction to perform the vibration control; and
the controller is configured or programmed to, upon receipt of the instruction by the input interface, perform the vibration control instead of the control by the manual operation.

12. The working vehicle according to claim 1, wherein the controller is configured or programmed to acquire a travel state of the travel vehicle body that is configured to be caused to travel by the traveling device, and stop or not perform the vibration control if determining that the traveling device is causing the travel vehicle body to travel based on the travel state.

13. The working vehicle according to claim 10, wherein the controller is configured or programmed to acquire at least one of a specific position on the travel vehicle body or a specific position on the working device linked to the linkage, and stop or prevent upward movement of the linkage by the manual operation or stop or not perform the vibration control if, based on the at least one of the specific position on the travel vehicle body or the specific position on the working device, determining that at least one of the specific position on the travel vehicle body or the specific position on the working device is located in a work area in which work is performed.

14. The working vehicle according to claim 10, wherein the controller is configured or programmed to acquire a travel state of the travel vehicle body that is configured to be caused to travel by the traveling device, and stop or prevent downward movement of the linkage caused by the manual operation if determining that the travel vehicle body is turning based on the travel state.

15. The working vehicle according to claim 1, wherein
the drive actuator and the traveling device are configured to be driven directly or indirectly by electricity discharged from a battery; and
the controller is configured or programmed to stop or not perform driving of the drive actuator in the vibration control when a remaining charge level of the battery is less than a predetermined level.
